(19) United States
(12) Patent Application Publication
(10) Pub. No.: US 2026/0231200 A1
(43) Pub. Date: Aug. 6, 2026

(54) METHODS AND APPARATUSES FOR ENHANCED CELL SELECTION IN FULL DUPLEX (FD) SYSTEMS

(71) Applicant: InterDigital Patent Holdings, Inc., Wilmington, DE (US)

(72) Inventors: Nazli Khan Beigi, Longueuil (CA); Jonghyun Park, Syosset, NY (US); Moon IL Lee, Melville, NY (US); Paul Marinier, Brossard (CA); Aata El Hamss, Laval (CA); Virgile Garcia, Antibes (FR)

(73) Assignee: InterDigital Patent Holdings, Inc., Wilmington, DE (US)

(21) Appl. No.: 19/046,004

(22) Filed: Feb. 5, 2025

(51) Int. Cl. H04W 72/541; H04B 7/0456; H04B 17/318; H04W 28/18

(52) U.S. Cl. CPC H04W 72/541; H04B 7/0486; H04B 17/318; H04W 28/18

(57) ABSTRACT

A wireless transmit/receive unit (WTRU) may measure a signal strength of first synchronization signal block (SSB) bursts received from a first base station associated with a first cell and calculate its cell ranking value. The WTRU may receive configuration information for receiving second and third SSB bursts from a second base station associated with a second cell. The WTRU may measure a signal strength of the second SSB bursts received during first SSB symbols. The WTRU may measure cross-link interference (CLI)-received signal strength indicator (RSSI) based on signals received during the first SSB symbols. The WTRU may measure a signal strength of the third SSB bursts when the measured CLI-RSSI is above a threshold. The WTRU may calculate a cell ranking value of the second cell based on the measured signal strengths of the second and third SSB bursts and select a cell with a highest calculated cell ranking value.

### BACKGROUND

New Radio (NR) duplex operation may provide a foundation in improving conventional time division duplexing (TDD) operation by enhancing UL coverage, improving capacity, reducing latency. The conventional TDD is based on splitting the time domain between the uplink and downlink. Full duplex, or more specifically, sub-band non-overlapping full duplex (SBFD) at the gNB within a conventional TDD band, may be used.

### SUMMARY

Procedures and apparatuses for enhanced cell (re) selection in the presence of wireless transmit/receive unit (WTRU)-to-WTRU cross-link interference (CLI), which may be used full duplex (FD) systems, are disclosed herein. A WTRU may measure a signal strength of one or more first synchronization signal block (SSB) bursts received from a first base station associated with a first cell (e.g., the serving cell of the WTRU) and may calculate a cell ranking value of the first cell. The WTRU may receive, from the first base station, configuration information for receiving one or more second SSB bursts from a second base station associated with a second cell and configuration information for receiving one or more third SSB bursts from the second base station associated with the second cell. In an example, the one or more second SSB bursts are of a first type and the one or more third SSB bursts are of a second type (first and second type may be same or different) and/or the third SSB bursts have a different periodicity than the second SSB bursts (alternatively, the periodicities may be the same). The WTRU may measure a signal strength of the one or more second SSB bursts received from the second base station, wherein the one or more second SSB bursts are received during first SSB symbols. The WTRU may measure cross-link interference (CLI)-received signal strength indicator (RSSI) based on one or more signals received during the first SSB symbols. In an example, the CLI-RSSI may be measured in one or more uplink subbands. Based on the measured CLI-RSSI being above a threshold, the WTRU mayS measure a signal strength of the one or more third SSB bursts received from the second base station. The WTRU may calculate a cell ranking value of the second cell based on the measured signal strength of the one or more second SSB bursts and the measured signal strength of the one or more third SSB bursts. The WTRU may perform cell selection by selecting a cell with a highest calculated cell ranking value.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a frame format diagram illustrating an example time division duplex (TDD) framework 200 with sub-band non-overlapping full duplex (SBFD) configuration;

FIG. 3 is a system diagram illustrating an example radio access network (RAN) illustrating an example scenario of WTRU-to-WTRU cross-layer interference (CLI) in LTM systems;

FIG. 4 is flow diagram illustrating an example enhanced cell (re) selection procedure in the presence of WTRU-to-WTRU CLI, that may be performed by a WTRU in an SBFD system; and

FIG. 5 is a scheduling diagram illustrating an example configuration in time and frequency resources of first type SSB bursts and second type SSB bursts having different periodicity.

### DETAILED DESCRIPTION

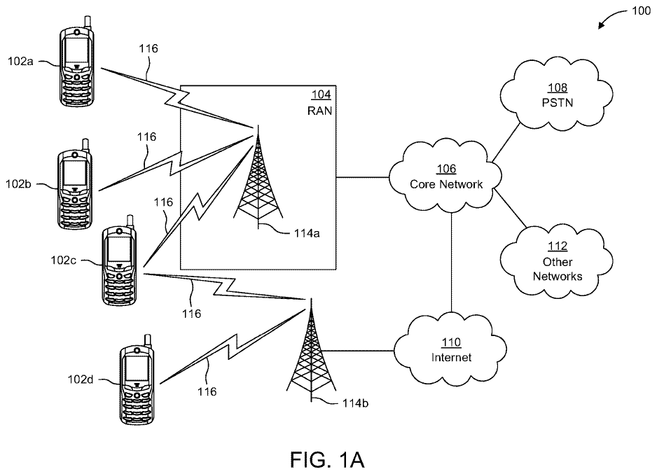

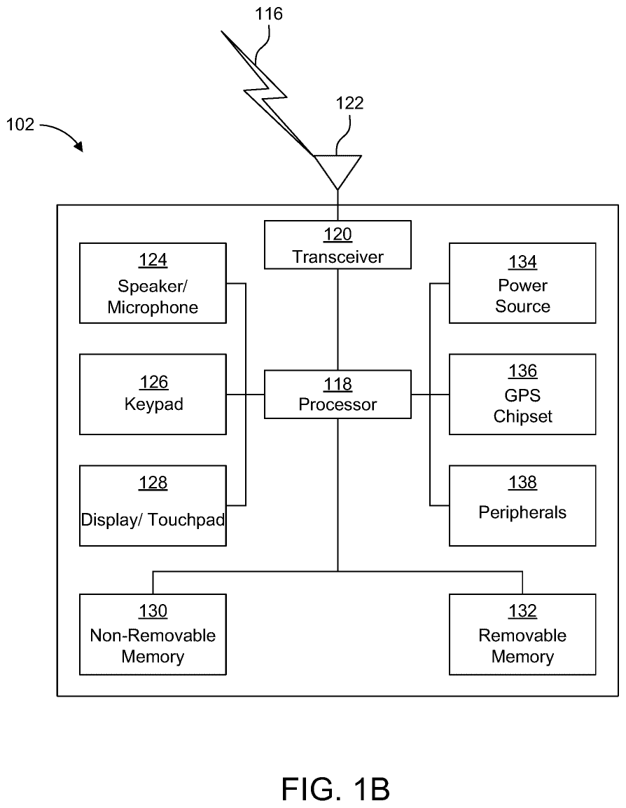

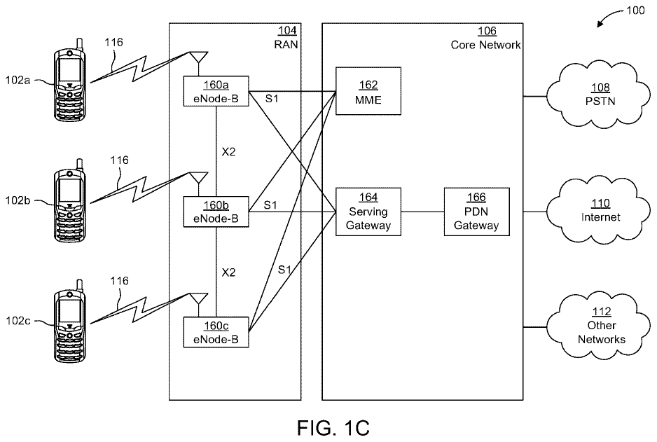

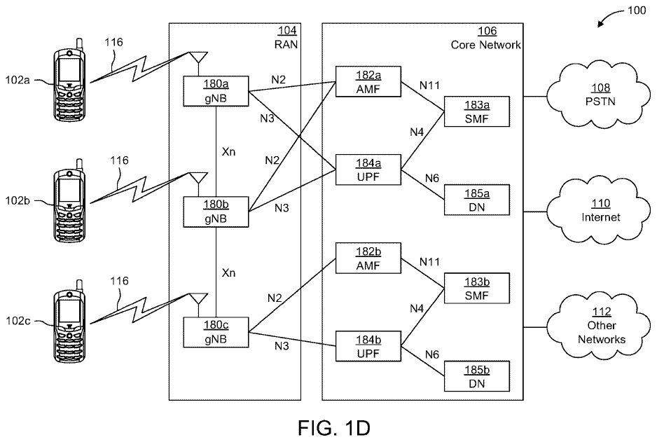

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, For example using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’. A WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving a reference signal (RS) (such as Channel State Information-Reference Signal (CSI-RS) CSI-RS) or a SS block. The WTRU transmission may be referred to as “target”, and the received RS or synchronization signal (SS) block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal.

A spatial relation may be implicit, configured by radio resource control (RRC) signaling or signaled by MAC CE or downlink control information (DCI). For example, a WTRU may implicitly transmit signals on physical uplink shared channel (PUSCH) and Demodulation Reference Signal (DM-RS) of PUSCH according to the same spatial domain filter as a sounding reference signal (SRS) indicated by an SRS resource indicator (SRI) indicated in downlink control information (DCI) or configured by RRC signaling. In another example, a spatial relation may be configured by RRC for an SRI or signaled by MAC CE for a physical uplink control channel (PUCCH). Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as physical downlink control channel (PDCCH) or physical downlink shared channel (PDSCH) and its respective DM-RS. At least when the first and second signals are reference signals, such association may exist when the WTRU is configured with a quasi-colocation (QCL) assumption type D between corresponding antenna ports. Such association may be configured as a transmission configuration indication (TCI) state. A WTRU may be indicated an association between a CSI-RS or SS block and a DM-RS by an index to a set of TCI states configured by RRC and/or signaled by MAC CE. Such indication may also be referred to as a “beam indication”.

A Synchronization Signal Block (SSB) or synchronization signal (SS)/physical broadcast channel (PBCH) block (SSB) may include at least one of the following: a Primary Synchronization Signal (PSS), a Secondary Synchronization Signal (SSS), a Physical Broadcast Channel (PBCH) (e.g., Data, MIB), and/or physical broadcast channel (PBCH) (e.g. demodulation reference signal (DMRS)). The SSBs may be transmitted in SSB bursts by the network (NW) node (e.g., base station, TRP, relay node, Reconfigurable Intelligent Surfaces (RIS) unit) in different directions as beams. An SSB burst may consist of multiple SSBs, where the different SSBs may be transmitted in configured time and frequency resources. The maximum number of SSB beams in an SSB burst set that may be transmitted periodically within an interval (e.g. 5 ms) may depend on the carrier frequency. For example, an SSB burst may contain a maximum of 4 SSBs for frequency resource FR1 (<3 GHZ), 8 SSBs for frequency resource FR2 (3 to 6 GHZ) and 64 SSBs for frequency resource FR3. Certain SSBs may be transmitted as on-demand SSBs (OD-SSBs), which may consist of a subset of SSBs in a burst. Such OD-SSBs may be transmitted aperiodically, semi-persistently, or periodically with a given periodicity. The transmission of OD-SSBs may be triggered by the network node or the WTRU (e.g., via transmission of an uplink (UL) wakeup signal (WUS)). Some SSBs may include slim/lean SSBs, which may comprise for example PSS only, PSS and SSS-only, PBCH or a subset of MIB-only.

Herein, a transmission and reception point (TRP) may be interchangeably used with one or more of transmission point (TP), reception point (RP), radio remote head (RRH), distributed antenna (DA), base station (BS), a sector (of a BS), and a cell (e.g., a geographical cell area served by a BS). Herein, Multi-TRP may be interchangeably used with one or more of MTRP, M-TRP, and multiple TRPs.

Herein, the term “subband” and/or “sub-band” is used to refer to a frequency-domain resource and may be characterized by at least one of the following: a set of resource blocks s); a set of resource block (RB) sets (e.g. when a carrier has intra-cell guard bands); a set of interlaced resource blocks; a bandwidth part (BWP), or portion thereof; and/or a carrier, or portion thereof. For example, a subband may be characterized by a starting RB and a number of RBs for a set of contiguous RBs within a bandwidth part. A subband may also be defined by the value of a frequency-domain resource allocation field and bandwidth part index.

Herein, the term “XDD” is used to refer to a subband-wise duplex (e.g., either UL or DL being used per subband) and may be characterized by at least one of the following: cross Division Duplex (e.g., subband-wise Frequency Division Duplexing (FDD) within a TDD band); subband non-overlapping full duplex (SBFD); subband-based full duplex (e.g., full duplex as both UL and DL are used/mixed on a symbol/slot, but either UL or DL being used per subband on the symbol/slot); frequency-domain multiplexing (FDM) of DL/UL transmissions within a TDD spectrum; a full duplex other than a same-frequency (e.g., spectrum sharing, subband-wise-overlapped) full duplex; and/or an advanced duplex method (e.g., other than pure TDD or FDD).

Herein, the term “dynamic (or flexible) TDD” is used to refer to a TDD system/cell that may dynamically (and/or flexibly) change/adjust/switch a communication direction (e.g., a downlink, an uplink, or a sidelink, etc.) on a time instance (e.g., slot, symbol, subframe, and/or the like). In an example, in a system employing dynamic/flexible TDD, a component carrier (CC) or a bandwidth part (BWP) may have one single type among ‘D’ (downlink), ‘U’ (uplink), and ‘F’ (flexible) on a symbol/slot, based on an indication by a group-common (GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In an example, the first WTRU may determine that the reception of the downlink signal is being interfered by the uplink signal, where the interference caused by the uplink signal may refer to a WTRU-to-WTRU cross-layer interference (CLI).

A WTRU may be operating during at least one of the one or more RRC states and/or RRC modes, for example including RRC-Connected state, RRC-Inactive state, and/or RRC-Idle state. A WTRU may be operating in an RRC-Connected state, during which the WTRU may have connected, established RRC context, and/or have at least one RRC connection, for example, to one or more cells, base stations, gNBs, TRPs, etc. In RRC-Connected state, the WTRU may receive RRC context and/or one or more configuration information at least including one or more radio bearers, logical channels, PDU sessions, security information, etc. During RRC-Connected state, the connected WTRU may measure one or more reference signal received power (RSRP), reference signal received quality (RSRQ), received signal strength indicator (RSSI), etc. based on one or more received, detected, configured, and/or indicated reference signals (RSs) received from serving cell and/or one or more neighboring cells. The connected WTRU may report the measured parameters, for example to the serving cell.

A WTRU may be operating in an RRC-Idle state, that may be the initial mode when the WTRU is powered up. The WTRU is RRC-Idle state is in a dormant state where the WTRU is not actively engaged in communication. The WTRU in RRC-Idle state may perform cell selection and/or cell reselection, where the WTRU receives, detects, measures, and/or selects an SSB, based on which the WTRU uses the physical broadcast channel (PBCH), master information block (MIB), system information block (SIB), etc. The WTRU in RRC-Idle state may monitor the PDCCH (e.g., DCI, Format 1-0 using the paging Radio Network Identifier (P-RNTI)) defined by the Discontinuous Reception (DRX) pattern. The WTRU may use respective 5G-S-TMSI to receive Paging messages in RRC-Idle state.

A WTRU may be operating in an RRC-Inactive state, where the WTRU keeps the RRC context and CORE network connection and do not release the RRC when switching from RRC-Connected state to RRC-Inactive state. The WTRU in RRC-Inactive state may be in a sleep mode, similar to RRC-Idle state, where the mobility may be handled through cell reselection without involvement of network.

Herein, downlink reception may be used interchangeably with Rx occasion, PDCCH, PDSCH, SSB reception. Herein, uplink transmission may be used interchangeably with Tx occasion, PUCCH, PUSCH, Physical Random-Access Channel (PRACH), SRS transmission. Herein, time instance, slot, symbol, and subframe may be used interchangeably. Herein, UL-only and DL-only transmission/reception (Tx/Rx) occasions may interchangeably be used with legacy TDD UL or legacy TDD DL, respectively. In an example, the legacy TDD UL transmission or legacy DL reception occasions are the cases where SBFD is not configured and/or where SBFD is disabled.

Herein, the terms received signal power, received signal energy, received signal strength, SSB Energy Per Resource Element (EPRE), CSI EPRE, RSRP, RSSI, signal-to-interference-plus-noise ratio (SINR), reference signal received quality (RSRQ), SS-RSRP, SS-RSSI, SS-SINR, SS-RSRQ, CSI-RSRP, CSI-RSSI, CSI-SINR, and CSI-RSRQ may be used interchangeably. Herein, the term CLI may be used interchangeably with interference. Herein, the term non-SBFD may be used interchangeably with operation without SBFD, TDD, legacy TDD. Herein, the terms ‘paired spectrum’ and FDD may be used interchangeably. Herein, the terms ‘unpaired spectrum’ and TDD may be used interchangeably. Herein, the terms ‘WTRU is configured’, ‘WTRU is indicated’, ‘WTRU receives configuration’, may imply that the configuration is indicated for example ‘via RRC, MAC-CE, DCI, MIB, SIB’, unless indicated otherwise, where for example, ‘WTRU is configured’ may imply ‘WTRU is configured via RRC, MAC-CE, MIB, SIB’.

Herein, the terms target and candidate may be used interchangeably. For example, the terms target cell and candidate cell may be used interchangeably. In another example, the terms target beam and candidate beam may be used interchangeably. For illustrative purposes, the channel quality parameters may comprise the RSRP, however the example embodiments and solutions disclosed herein may equally (or equivalently or extendedly, etc.) be employed (e.g., applicable) for cases with other quality parameters and/or values (e.g., RSRQ, SINR, etc.).

Subband non-overlapping full duplex (SBFD) is described herein. A WTRU may receive configurations (e.g., from a gNB, a node, or a device) for full-duplex (FD) operation conducted by at least one device in a network. In an example, the FD operation may be conducted by a gNB (e.g., a BS, a node, a TRP, a cell). The WTRU may operate in a half-duplex (HD) mode for communicating with the gNB, where the HD mode may imply at a given time the WTRU either performs a UL transmission or a DL reception (e.g., not both UL and DL simultaneously at the given time). The WTRU may (also) operate in an FD mode for communicating with the gNB (e.g., if a corresponding WTRU capability signal(s) is reported to the gNB and/or the WTRU receives a confirmation signal (e.g., enabling the FD, configuring the FD mode) in response to transmitting the WTRU capability signal(s)).

The FD operation may imply at a given time a transmitter (e.g., the gNB and/or the WTRU) may simultaneously transmit a first signal and receive a second signal. The FD operation may comprise a subband overlapping FD (e.g., in-band FD (IBFD) operation where a first frequency-domain resource (e.g., resource block group (RBG) (s), resource block (RB) (s), resource element (RE) (s) allocated for the first signal may have a full (or at least a partial) overlap with a second frequency-domain resource allocated for the second signal. The FD operation may comprise a subband non-overlapping FD (SBFD) operation where a first frequency-domain resource allocated for the first signal (e.g., assigned within a configured SBFD subband (e.g., DL subband, usable DL PRBs) does not have an overlap with a second frequency-domain resource allocated for the second signal (e.g., assigned within a configured SBFD subband, for example an UL subband, and/or usable UL PRBs).

Herein, for illustrative purposes, the FD operation may comprise the SBFD operation, however the example embodiments and solutions disclosed herein may equally (or equivalently or extendedly, etc.) be employed (e.g., applicable) for cases with other FD operation types (e.g., IBFD, etc.).

A WTRU may be configured with one or more types of slots within a bandwidth, wherein a first type of slot may be used or determined for a first direction (e.g., downlink); a second type of slot may be used or determined for a second direction (e.g., uplink); a third type of slot may have a first group of frequency resources within the bandwidth for a first direction and a second group of frequency resources within the bandwidth for a second direction. Herein, the bandwidth may be interchangeably used with bandwidth part (BWP), carrier, subband, and system bandwidth. The first type of slot (e.g., the slot for a first direction) may be referred to as downlink slot. The second type of slot (e.g., slot for a second direction) may be referred to as uplink slot. The third type of slot may be referred to as Sub-Band (non-overlapping) Full Duplex (SBFD) slot. The group of frequency resource for a first direction may be referred to as downlink subband, downlink frequency resource, or downlink RBs. The group of frequency resource for a second direction may be referred to as uplink subband, uplink frequency resource, or uplink RBs. The group of frequency resource for a flexible direction (e.g., that may be configured for a first direction, second direction, etc.) may be referred to as flexible subband, flexible frequency resource, or flexible RBs. The group of frequency resource between a first direction and a second direction may be referred to as guard band, guard frequency resource, or guard RBs.

In an example, a (SBFD-enabled) WTRU may receive or be configured with one or more SBFD UL or DL subbands in one or more DL, UL, and/or flexible TDD time instances (e.g., symbols, slots, frames). The WTRU may be configured with one or more resource allocations for SBFD subbands.

For example, the SBFD configuration may include a flag signal (e.g., enabled/disabled), where for example a first value (e.g., zero (0) indicates a first mode of operation (e.g., based on SBFD resources and/or configurations), and a second value (e.g., one (1)) may indicate a second mode of operation (e.g., based on non-SBFD resources and/or configurations). The modes of operation (e.g., SBFD or non-SBFD) may be indicated via, for example MIB, SIB, RRC, MAC-CE, DCI.

Herein, the term “WTRU operating based on SBFD operation” may indicate WTRU performing Tx/Rx based on SBFD resources and/or configurations. Herein, the term “WTRU operating based on non-SBFD operation” may indicate WTRU performing Tx/Rx based on non-SBFD resources and/or configurations.

The WTRU may receive the time resources (e.g., one or more symbols, slots), for which the first mode of operation (e.g., SBFD) is defined in for example one or more BWPs, subbands, component carriers (CC), cells. The WTRU may receive the frequency resources (e.g., subbands, BWPs, etc. including one or more PRBs) within (active and/or linked) BWP, for which the first mode of operation (e.g., SBFD) is configured. The time instances (e.g., slots, symbols) may be indicated based on periodic, semi-persistent, or aperiodic configurations. In an example, the time instances may be indicated via a bitmap configuration, where each bit corresponds to a time instance (e.g., slot, symbol, subframe, etc.) and each bit indication indicates whether corresponding time instance may be used for the first or second mode of operation.

In an example, a WTRU may be configured with a DL TDD configuration for a component carrier (CC) or a BWP for one or more Rx occasions (e.g., via tdd-UL-DL-config-common, dedicated configurations, slot format indicator (SFI)). As such, if the first mode of operation (e.g., SBFD) is configured, one or more of the configured frequency resources (e.g., subbands, PRBs, and/or BWPs) may be configured for the transmission in UL channels and/or Tx occasions.

In another example, the WTRU may be configured with an UL TDD configuration for a component carrier (CC) or a BWP for one or more Tx occasions (e.g., via tdd-UL-DL-config-common, dedicated configurations, slot format indicator (SFI)). As such, if the first mode of operation (e.g., SBFD) is configured, one or more of the configured frequency resources (e.g., subbands, PRBs, and/or BWPs) may be configured as the DL channels and/or Rx occasions.

In another example, the WTRU may be configured with a DL, UL, or Flexible TDD configuration for a component carrier (CC) or a BWP for one or more Rx/Tx occasions (e.g., via tdd-UL-DL-config-common, dedicated configurations, slot format indicator (SFI)). As such, if the first mode of operation (e.g., SBFD) is configured, one or more of the configured frequency resources (e.g., subbands, PRBs, and/or BWPs) may be configured for the first mode of operation (e.g., either UL transmission or DL reception based on the configurations).

In an example, the duplexing mode for the first mode of operation (e.g., SBFD configuration (UL/DL)) may be indicated via a flag indication, where for example a first value (e.g., zero (0) may indicate a first direction (e.g., UL duplexing mode), and a second the value (e.g., one (1) may indicate a second direction (e.g., DL duplexing model). In an example, the duplexing mode configuration and/or flag for the first mode of operation (e.g., SBFD) may be configured as part of modes of operation configuration, for example via MIB, SIB, RRC, DCI, MAC-CE, etc. In an example, the duplexing mode configuration and/or flag for the first mode of operation (e.g., SBFD) may be configured as part of resource allocation configuration for a Tx/Rx occasion.

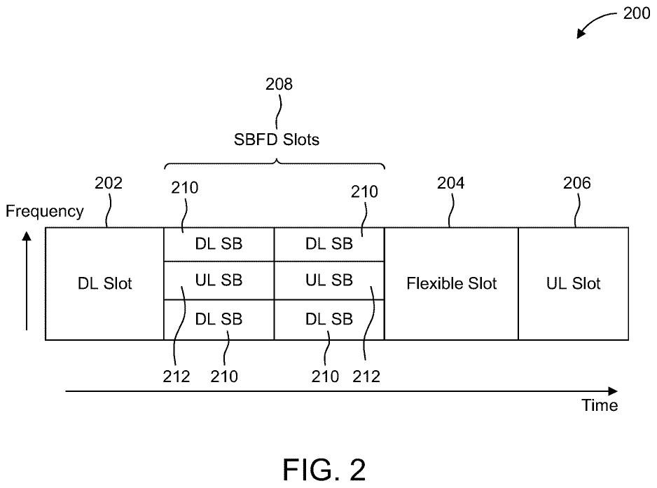

In an example, the WTRU may be configured with DUD configuration, where an UL subband is configured between two DL subbands (See for example FIG. 2). In another example, the WTRU may be configured with UD configuration, where an UL subband is configured with higher frequencies followed by a DL subband with lower frequencies. In another example, the WTRU may be configured with DU configuration, where a DL subband is configured with higher frequencies followed by au UL subband with lower frequencies. These examples are non-limiting examples of the SBFD configurations and parameters that may be included in SBFD configurations. One or more of those configurations may be included. Other configurations may be included.

In an example, a WTRU may be configured with one or more types of slots. The WTRU may be configured with a first slot with a first type, where the first type may be for example SBFD slot. The WTRU may be configured with a second slot with a second type, where the second type may be for example non-SBFD slot. As for the first slot with the first type (e.g., SBFD), the WTRU may be configured with one or more DL, UL, flexible, guard, etc. subbands in the frequency domain, throughout the BWP, for the duration of the first slot. In the second slot with the second type (e.g., non-SBFD), the WTRU may be configured with direction type, for example DL, UL, flexible, etc., in the frequency domain, throughout the BWP, for the duration of the second slot.

In an example, if the WTRU is configured with a second slot with UL direction, this may indicate legacy TDD UL slot, UL-only slot, and/or non-SBFD UL slot. In another example, if the WTRU is configured with a third slot with second type (e.g., non-SBFD) with DL direction, this may indicate legacy TDD DL slot, DL-only slot, and/or non-SBFD DL slot. In another example, if the WTRU is configured with a fourth slot with second type (e.g., non-SBFD) with flexible direction, this may indicate legacy TDD flexible slot and/or non-SBFD flexible slot.

CLI measurement is described herein. A WTRU may be configured, determined, or indicated to perform a measurement of cross-link interference (CLI) Received Signal Strength Indicator (RSSI) in a given time period, wherein the given time period may be one or more slots, OFDM symbols, resource blocks (RBs), and/or resource elements (REs). The CLI-RSSI, which may be measured in a given time and/or frequency resource, may be referred to as L1-CLI-RSSI, short-term CLI-RSSI, aperiodic CLI-RSSI. Alternatively, the WTRU may be configured, determined, or indicated to perform a measurement of Reference Signal Received Power (RSRP) based on one or more reference signals (e.g., SRS-RSRP) in the context of CLI measurement in a given time period, wherein the given time period may be one or more slots, OFDM symbols, resource blocks (RBs), and/or resource elements (REs). The SRS-RSRP which may be measured in a given time and frequency resource may be referred to as L1-SRS-RSRP, short-term SRS-RSRP, aperiodic SRS-RSRP, SRS-RSRP-CLI.

Herein, the terms CLI-RSSI, L1-CLI-RSSI, and RSSI may be used interchangeably. Herein, the terms SRS-RSRP, SRS-RSRP-CLI, L1-SRS-RSRP, and RSRP may be used interchangeably.

L1/L2 CLI measurement is described herein. One or more RSSI (or RSRP) types may be used and a WTRU may be configured to perform one or more RSSI (or RSRP) types, wherein a first RSSI (or RSRP) type may be based on a measurement over a long time period (e.g., more than one slot) (e.g., L3 measurements) and the measurement is reported via a higher layer signaling (e.g., RRC, MAC). A second RSSI (or RSRP) type may be based on a measurement over a short time period (e.g., L1 measurements) (e.g., one slot, within a slot, one or more OFDM symbols within a slot) and the measurement is reported via a L1 signaling (e.g., PUCCH, PUSCH, Random Access Channel (RACH), SRS). RSSI may be interchangeably used with RSRP, RSRQ, and SINR. CLI-RSSI may be interchangeably used with SRS-RSRP and SINR.

The WTRU may be configured with one or more sets of time and frequency resources for measuring CLI (e.g., SRS-RSRP) (e.g., a new IE SRS-RSRP-MeasurementResourceSet) containing one or more sets of configuration information of SRS-RSRP measurement resource(s) (e.g., SRS-RSRP-MeasurementResource), for example for L1 SRS-RSRP measurement. The SRS-RSRP measurement resource configurations may include number of SRS ports, transmission comb, time resource mapping such as start position, number of symbols, repetition, frequency resources, frequency hopping, resource type such as periodic, aperiodic, semi-persistent, sequence ID used for SRS.

The WTRU may be configured with one or more sets of time and frequency resources for measuring CLI (e.g., CLI-RSSI) (e.g., a new IE CLI-RSSI-MeasurementResourceSet) containing one or more sets of configuration information of CLI-RSSI measurement resource(s) (e.g., CLI-RSSI-MeasurementResource), for example for L1 CLI-RSSI measurement. The CLI-RSSI measurement resource configurations may include CLI-RSSI measurement resource ID, starting PRB index, number of PRBs, starting symbol of the CLI-RSSI resource within a slot, number of symbols of the CLI-RSSI resource within a slot, periodicity and slot offset for the CLI-RSSI resource.

The WTRU may be configured with a set of time and frequency resources to measure L1-CLI-RSSI, wherein the time and frequency resources for L1-CLI-RSSI measurement may be referred to as CLI-RSSI Measurement Resource (CRMR). For example, CRMR may be a resource configured, determined, or defined (e.g., via RRC, MAC-CE, DCI) (e.g., via CLI-ResourceConfig, CLI-ResourceConfig-r-16) with any one or more of following example properties. An example property includes a set of muted resource elements (REs) in downlink resource (e.g., PDSCH), wherein the muted REs may be rate-matched around or punctured for downlink reception and/or uplink transmission. The set of muted REs may have a same pattern (e.g., same time and frequency location) in each resource block (RB). The set of muted REs may have a different pattern based on the RB location. For example, a first pattern may be used for the RBs located in an edge of the scheduled RBs and a second pattern may be used for the RBs located in a center of the scheduled RBs. The first pattern and the second pattern may have a different number of muted REs. The muted REs may be in a form of zero-power resources (e.g., CSI-RS and/or ZP-CSI-RS).

An example property includes a set of REs not scheduled or used for the WTRU measuring CRMR. An example property includes a set of REs may be located in an RB which may be configured or determined as guard band (or guard RB). For example, a guard band (or guard RB) may be located in between uplink and downlink resources. A WTRU may skip receiving or transmitting a signal in guard band.

An example property includes a one or more reference signals (e.g., DMRS, SRS, sidelink CSI-RS, etc.).

An example property includes a second set of DMRS REs within a second code division multiplexing (CDM) group (e.g., within a scheduled downlink resource and/or RBs, for example of PDSCH), where a WTRU may receive a DCI, scheduling the PDSCH, indicating a first set of DMRS REs corresponding to a first CDM group to be used for receiving the PDSCH. In an example, the WTRU may receive the DCI, scheduling the PDSCH, indicating a first set of DMRS REs corresponding to a first CDM group (based on an indicated ‘(DMRS) antenna port’ field of the DCI. In response to receiving the DCI, the WTRU may determine that a second set of DMRS REs within a second CDM group (other than the first CDM group) may be used as the CRMR (e.g., within the scheduled PDSCH). An example property includes located within a scheduled resource (e.g., scheduled PDSCH RBs).

CRMR may be configured commonly for a set of WTRUs (e.g., WTRUs in proximity). For example, a gNB may configure a CRMR for a group of WTRUs, wherein the group of WTRUs may share one or more of following: a group-ID to receive a DCI (e.g., a group-Radio Network Identifier (group-RNTI); a zone-ID, wherein the zone-ID may be determined based on a geographical location of the WTRU (e.g., GNSS); and/or WTRUs paired for sidelink unicast (or groupcast) transmission.

L1-CLI-RSSI measurement (including CRMR resource) may be considered as CSI reporting quantity and configured as a part of CSI reporting setting. CRMR may be configured in a first subband type (e.g., DL subbands) to measure the (effect of) one or more reference signals received in a second subband type (e.g., UL subbands). As such, the reference signals may be received and measured in resources that may be identified as zero-power or muted resources. The WTRU may be configured, determined, or indicated to measure the effect of reference signals being transmitted in other resources (e.g., second type resources, such as UL subbands) in these resources (e.g., first type resources, such as DL subbands). For example, a first WTRU may be configured to measure SRS-RSRP in DL subbands on an SBFD configuration, where the SRS is transmitted by a second WTRU in the UL subbands. In an example, the first WTRU may measure SRS-RSRP based of the configured SRS signaling in the DL subbands. In another example, the WTRU may measure the CLI-RSSI based on the configured SRS signaling in the UL subbands.

Delta-CLI measurement is described herein. The WTRU may be configured, determined, or indicated to perform a delta CLI-RSSI, which may be based on a first CLI-RSSI measurement in a first time and/or frequency location and a second CLI-RSSI measurement in a second time and/or frequency location. One or more of following deltas may apply. An example delta is the delta CLI-RSSI (delta-CLI-RSSI) may be a difference between a first CLI-RSSI (e.g., CLI-RSSI1) and a second CLI-RSSI (e.g., CLI-RSSI2) (e.g., delta-CLI-RSSI=CLI-RSSI1-CL-RSSI2 (or delta-CLI-RSSI=CLI-RSSI2-CL-RSSI1, etc.)). Another example delta is the first CLI-RSSI may be measured from CRMR resources located in the edge of the scheduled RBs while the second CLI-RSSI may be measured from CRMR resources located in the middle of the scheduled RBs. Another example delta is a WTRU may be configured with a first CRMR resource for the first CLI-RSSI measurement and a second CRMR resource for the second CLI-RSSI measurement. Another example delta is a WTRU may determine to report CLI measurement related information when a measured delta-CLI-RSSI is larger than a threshold. For example, CLI reporting may be triggered based on delta-CLI-RSSI measurement is larger than a threshold, wherein the threshold may be predetermined or configured.

Bandwidth and/or Subband configuration for CLI measurement is described herein. The WTRU may be configured or may determine to measure CLI-RSSI per subband level. For example, a subband may be configured, or predetermined and a WTRU may perform CLI-RSSI measurement in each subband. One or more of following considerations may apply. In an example, subband size may be determined based on the number of scheduled RBs (e.g., for PDSCH). In another example, the WTRU may report CLI-RSSI measurement for all subbands. In another example, the WTRU may report a subset of CLI-RSSI, wherein the subset may be determined based on one or more conditions (e.g., CLI-RSSI value above threshold, subband location (e.g., edge of scheduled RBs), and/or subband index).

The WTRU may determine a bandwidth of beam measurement and/or reporting (e.g., wideband or subband) based on any one or more of following conditions: Time unit type (e.g., SBFD or non-SBFD), for example, a WTRU may report wideband CRI (e.g., wideband beam index) in non-SBFD time units (e.g., symbol, slot) and the WTRU may report subband CRI (e.g., subband beam index) in SBFD time units; and/or presence of CLI-RSSI measurement, for example the bandwidth of beam measurement/reporting is determined based on whether CLI-RSSI is measured in the same slot or not.

The WTRU may be indicated to perform CLI-RSSI measurement in a specific frequency location within a scheduled RBs (or non-scheduled RBs), wherein the specific frequency location may be one or more of subbands, RBs, and REs. The indication may be in a DCI which may trigger the CLI-RSSI measurement (e.g., aperiodic CLI-RSSI measurement). The specific frequency location may be indicated based on the CRMR resource frequency location. For example, one or more CRMR resources may be configured and each CRMR resource may be located in a specific frequency location based on configuration. The WTRU may be indicated to perform measurement on CRMR resource indicated in a DCI.

SRS Types are described herein. The WTRU may be configured or indicated to transmit one or more SRSs, where an SRS resource of the one or more SRSs may be configured for a particular purpose of at least one of: beam management, channel acquisition (e.g., based on channel reciprocity), link adaptation, antenna switching. The mentioned particular purpose may be interpreted to be for a communication link between the WTRU and a gNB (e.g., its serving gNB, cell, TRP, or a target cell, gNB, TRP during cell switching, etc.), which may be denoted by a first SRS type. The first SRS type is a non-limiting example of a type of SRS that may be used for or to support a communication link between the WTRU and its serving cell, TRP, and/or gNB.

The WTRU may be configured or indicated to transmit second one or more SRS resources at least for CLI measurement purpose at a receiver side, which may be denoted by a second SRS type (e.g., CLI-SRS). The second SRS type is a non-limiting example of a type of SRS that may be used for or to support at least the CLI measurements at a receiver side (e.g., other WTRU(s), gNB(s), other communication device and/or node in the network). Any other type of transmission may be substituted for the transmission based on the second SRS type and still be consistent with example embodiments and solutions disclosed herein. The CLI measurements at the receiver side (e.g., a second WTRU) include, but or not limited to include, any one or more of the following: an energy-level or power-level measurement (e.g., CLI-RSSI) on a configured or indicated DL resource (e.g., a form of zero-power resource, a configured CLI-measurement resource, and/or the like); a sequence-based and/or correlation-based RS power measurement (e.g., SRS-RSRP) on a configured or indicated RS sequence and/or resource (e.g., SRS resource which may be transmitted from the WTRU causing the CLI to the second WTRU); and/or a signal-to-interference-plus-noise ratio (SINR) or channel quality indicator (CQI) type of channel quality metric derivation to be reported.

Cell-Level mobility is described herein. A WTRU may determine, identify, receive, be configured, and/or indicated to perform cell switch from the WTRU's serving cell to a determined, identified, configured, and/or indicated target cell. In an example, the WTRU may be in RRC-Connected state. During RRC-Connected state, the mobility of the WTRU may be handled and/or controlled by the NW. During RRC-Connected state, the connected WTRU may perform one or more Radio Resource Management (RRM) measurements and report the RRM measurements, for example to its serving cell. The connected WTRU may receive a request, command, and/or indication to switch from the serving cell to a target and/or candidate neighboring cell.

In the case of handover (HO), a WTRU may receive, be configured, and/or indicated with a HO command from a serving cell, where the (intra-NR) RAN handover preparation and execution may be performed based on one or more message exchanges, for example between gNBs. For example, the WTRU may determine, be configured, and/or indicated to reset the MAC entity and re-establish RLC, etc. during handover mechanism triggered by RRC. In an example, during HO preparation, the source and target gNBs may establish in-between user-plane (U-plane) tunnels. In another example, during HO execution, user data may be forwarded from source gNB to the target gNB. In another example, the data forwarding from the source gNB may continue until UPF or the source gNB's buffer is emptied.

In the case of conditional Handover (CHO), a WTRU may receive, be configured, and/or indicated with a CHO command from a serving cell, wherein the WTRU may perform the configured and/or indicated CHO when one or more configured and/or indicated handover execution conditions are met. In an example, the WTRU may receive the HO conditions via RRC, where the WTRU may evaluate the configured and/or indicated execution conditions upon receiving the CHO configurations. For example, the WTRU may stop evaluating the conditions when the HO is accomplished. For example, the WTRU may receive CHO configurations that may be generated by serving and/or source cell in addition to CHO configurations that may be generated by candidate and/or neighboring cells. In an example, a CHO condition may include one or more trigger conditions, for example, based on one or more measured RSRP, RSRQ, RSSI, SINR, etc. In case the WTRU determines that one or more of the CHO conditions for a candidate and/or target cell are satisfied, the WTRU may initiate HO to the corresponding target cell. In an example, the data forwarding between the source and target gNBs may be accomplished before or after HO execution, which may be addressed as early or late data forwarding, respectively.

In the case of L1/L2 Triggered Mobility (LTM), a WTRU may receive, be configured, and/or indicated to perform LTM cell switch to a candidate and/or target cell. For example, the WTRU may receive, identify, be configured, and/or indicated to send (L1) (RRM) measurement reports, for example to a gNB, where the gNB may change WTRU's serving cell to a target and/or candidate cell, via an LTM cell switch command, for example signaled by MAC-CE signaling. As part of the cell switch command, the WTRU may receive an indication to an LTM candidate (pre) configuration, for example regarding an LTM target cell, where the WTRU may have received the (pre) configured configuration information, for example via semi-static configurations (e.g., via RRC signaling). As such, the WTRU may switch to the configured and/or indicated LTM target cell based on the received LTM cell switch command.

A WTRU may be configured and/or indicated to initiate UL timing advance (TA) acquisition before LTM cell switching procedure, as in preparation phase. In an example, the WTRU may be indicated to send a PRACH to one or more candidate cells, where the WTRU may receive the indication, for example by a PDCCH order. As such, the WTRU may receive the TA command as part of LTM cell switch command. In another example, the WTRU may be configured and/or indicated to measure TA.

Depending on the availability of a valid TA value, a WTRU may perform either a RACH-less LTM or RACH-based LTM cell switch. In case the WTRU is provided with a valid TA value, for example in the cell switch command, the WTRU may apply the indicated TA value. In the case where WTRU-based TA measurement is configured and the WTRU is not provided with a valid TA value in the cell switch command, the WTRU may apply the valid TA value by itself. Therefore, the WTRU may perform RACH-less LTM cell switch upon receiving the cell switch command. If no valid TA value is available, the WTRU may perform RACH-based LTM cell switch toward the indicated target cell, where the WTRU may transmit the PRACH preamble indicated in LTM cell switch command, based on the indicated SSB index and PRACH Mask index.

In RACH-less LTM, a WTRU may access a target cell using one or more configured and/or dynamic grants. For example, the WTRU may be (pre) configured with the configured grant (e.g., including corresponding time-domain resource allocations (TDRA), frequency-domain resource allocations (FDRA), etc.), for example via the LTM candidate configuration (e.g., via RRC signaling). In an example, the WTRU may select the configured grant occasion associated with the beam indicated in the cell switch command (e.g., via indicated UL and/or DL TCI states). In an example, after LTM cell switch to the target cell, the WTRU may start monitoring PDCCH on the target cell for dynamic scheduling.

In an example, a WTRU performing LTM cell switch mechanism, for example triggered by MAC-CE, may reset the MAC entity, where the radio link control (RLC) and packet data convergence protocol (PDCP) handling may be configured, for example via RRC configuration.

Conditional layer 1/layer 2 (L1/L2) Triggered Mobility (LTM) is disclosed herein. A WTRU may receive, be configured, and/or indicated with a conditional LTM cell switch command from a serving cell, wherein the WTRU may perform the configured and/or indicated conditional LTM cell switch when one or more configured and/or indicated LTM cell switch conditions are met. In an example, the WTRU may receive the conditional LTM cell switch conditions via RRC, where the WTRU may evaluate the configured and/or indicated execution conditions upon receiving the conditional LTM cell switch configurations. For example, the WTRU may stop evaluating the conditions when the LTM cell switch is accomplished. For example, the WTRU may receive conditional LTM cell switch configurations that may be generated by serving and/or source cell in addition to conditional LTM cell switch configurations that may be generated by candidate and/or neighboring cells. In an example, a conditional LTM cell switch condition may include one or more trigger conditions, for example, based on one or more measured RSRP, RSRQ, RSSI, SINR, etc. In case the WTRU determines that one or more of the conditional LTM cell switch conditions for a candidate and/or target cell are satisfied, the WTRU may initiate LTM cell switch to the corresponding target cell. In an example, the data forwarding between the source and target gNBs may be accomplished before or after LTM cell switch, which may be addressed as early or late data forwarding, respectively.

Herein, the term “LTM cell switch” may interchangeably be used with HO, CHO, and conditional LTM cell switch. Herein, for illustrative purposes, the cell switching operation may comprise the LTM cell switching operation, however the example embodiments and solutions disclosed herein may equally (or equivalently or extendedly, etc.) be employed (e.g., be applicable) for cases with other cell switching operations (e.g., HO, CHO, conditional LTM, etc.).

L1 measurement is disclosed herein. An L1 measurement herein may consist of a measurement of RSRP, RSRP, RSSI, etc., performed by a WTRU of a cell, beam, set of cells, or set of beams. Such L1 measurement may be similar to L3 measurements reported in RRM, with differences in the filtering, reference signals measured, reporting mechanisms, etc. L1 measurement may apply also to RRM reporting. Herein, measurements refer to L1 measurements for LTM. However, certain solutions herein may apply also to RRM/L3 measurements, as well as other measurements (e.g., measurements of speed, location, height, traffic). Herein, reference is made to L1 measurement events, and L1 LTM mobility events, which use separate reporting mechanisms, resources, and triggers. However, certain solutions herein may also apply to any other type of measurement events of separate types which interact either in terms of the reporting mechanism or the evaluation mechanism.

LTM cell switch may apply also to any type of handover execution. Herein, the LTM cell switch refers to L1/L2 triggered mobility (LTM) whereby a preconfigured RRC configuration is applied when the WTRU receives an indication using MAC CE or when a certain condition is met at the WTRU. However, certain solutions may also apply to an RRC reconfiguration, an RRC conditional reconfiguration, as well as any other type of mobility procedure. LTM execution trigger herein refers to a condition for performing LTM (e.g. a conditional handover trigger or measurement report trigger), which is either configured or indicated by the network to the WTRU or estimated and/or determined by the WTRU.

An LTM execution trigger may be based on any of the following example triggers. An example trigger is time (e.g., absolute or relative time measured at WTRU, system frame number (SFN), subframe number, etc.). Another example trigger is radio quality measurement or predicted radio quality of one or more of the serving cells or target cells. Radio quality measurement or predicted radio quality triggers may include: RSRP (beam or cell); RSRQ (beam or cell); cri-RI-PMI-CQI; cri-RI-i1; cri-RI-i1-CQI; cri-RI-CQI; cri-RSRP; ssb-Index-RSRP; cri-RI-LI-PMI-CQI.

Another example trigger is position, which may include an area (e.g. defined by reference point and radius) or range of co-ordinates, and/or a distance threshold from a reference location. Another example trigger is L3 measurement events, which may include any of the following example events: Event A1 (Serving becomes better than threshold); Event A2 (Serving becomes worse than threshold); Event A3 (Neighbor becomes offset better than special cell (SpCell)); Event A4 (Neighbor becomes better than threshold); Event A5 (SpCell becomes worse than threshold1 and neighbor becomes better than threshold2); Event A6 (Neighbor becomes offset better than secondary cell (Scell)); Event B1 (Inter RAT neighbor becomes better than threshold); and/or Event B2 (primary cell (Pcell) becomes worse than threshold1 and inter RAT neighbor becomes better than threshold2). Another example trigger is L1 measurement event or conditions, for example any event defined which utilizes L1 beam measurements to evaluate whether a criteria or condition is met. For example, for LTM: Event LTM1: Beam of serving cell becomes better than absolute threshold; Event LTM2: Beam of serving cell becomes worse than absolute threshold; Event LTM3: Beam of candidate cell becomes amount of offset better than beam of serving cell; Event LTM4: Beam of candidate cell becomes better than absolute threshold; and/or Event LTM5: Beam of serving cell becomes worse than absolute threshold1 AND Beam of candidate cell becomes better than another absolute threshold2.

Another example trigger is time or location-based conditions, for example: Time measured at WTRU is within a duration from threshold; Distance between WTRU and referenceLocation1 is above threshold1 and distance between WTRU and referenceLocation2 is below threshold2; and/or Distance between WTRU and the serving cell moving reference location is above threshold1 and distance between WTRU and a moving reference location is below threshold2.

Another example trigger is combination of L3, L1, time, location-based conditions or events. For example, time measured at WTRU is within a duration from threshold AND Beam of candidate cell becomes better than absolute threshold, and so on. In another example, distance between WTRU and referenceLocation1 is above threshold1 and distance between WTRU and referenceLocation2 is below threshold2 AND Beam of candidate cell becomes amount of offset better than beam of serving cell. In another example, Distance between WTRU and the serving cell moving reference location is above threshold1 and distance between WTRU and a moving reference location is below threshold2 AND Beam of serving cell becomes worse than absolute threshold1 AND Beam of candidate cell becomes better than another absolute threshold2.

Cell (Re) Selection procedures are described herein. A WTRU may perform cell selection with or without stored cell information. The cell information may include frequencies and/or cell parameters. In an example, a cell may be defined as a combination of one or more uplink component carriers (CC) and one or more downlink component carriers. The WTRU may have (previously) stored information on one or more cells based on previously received measurement control information elements or from previously detected cells. If the WTRU has stored cell information, the WTRU may leverage it for cell selection.

In case there is no stored information, or if cell search based on the stored information has no results, the WTRU may perform initial cell selection, where the WTRU has no prior knowledge of the cell parameters. For example, the WTRU may not have knowledge of which RF channels are NR frequencies. As such, the WTRU may scan and/or monitor one or more RF channels for example from a set of RF channels (e.g., based on the synchronization raster frequencies) in the NR bands to find a suitable cell. For example, a synchronization raster may indicate the frequency positions of the synchronization block (e.g., SS/PBCH block) that may be used by the WTRU for system acquisition when explicit signaling of the synchronization block position is not present. As such, the WTRU may search to find the SS/PBCH blocks corresponding to one and more cells on each frequency channel and/or raster, where the WTRU may select the strongest cell based on the measuring the RSSI, RSRP, RSRQ, SINR for the detected SS/PBCH block.

The WTRU may receive one or more configuration information regarding the serving cell, neighbor cells, and/or one or more parameters and settings. In another example, Table 1 shows an example of parameters in SIB2, where SIB2 contains cell re-selection information common for intra-frequency, inter-frequency and/or inter-RAT cell re-selection (i.e., applicable for more than one type of cell re-selection but not necessarily all) as well as intra-frequency cell re-selection information other than neighboring cell related. In another example, Table 2 shows an example of parameters in SIB3, where SIB3 contains neighboring cell related information relevant for intra-frequency cell re-selection. The following parameters in Tables 1 and 2 are non-limiting examples of the parameters that may be included in cell (re) selection procedure. One or more of these parameters may be included, and other parameters not shown may be included.

TABLE 1
Example parameters in SIB2 for cell (re)selection procedure

| SIB2 ::= | SEQUENCE { | |
|---|---|---|
| cellReselectionInfoCommon | SEQUENCE { | |
| nrofSS-BlocksToAverage | INTEGER (2..maxNrofSS-BlocksToAverage | OPTIONAL, -- Need S |
| absThreshSS-BlocksConsolidation | ThresholdNR | OPTIONAL, -- Need S |
| rangeToBestCell | RangeToBestCell | OPTIONAL, -- Need R |

| | |
|---|---|
| q-Hyst | ENUMERATED { |

dB0, dB1, dB2, dB3, dB4, dB5, dB6, dB8, dB10,
dB12, dB14, dB16, dB18, dB20, dB22, dB24},

| | |
|---|---|
| speedStateReselectionPars | SEQUENCE { |
| mobilityStateParameters | MobilityStateParameters, |
| q-HystSF | SEQUENCE { |
| sf-Medium | ENUMERATED {dB−6, dB−4, dB−2, dB0}, |
| sf-High | ENUMERATED {dB−6, dB−4, dB−2, dB0}, |

}

| | |
|---|---|
| } | OPTIONAL, -- Need R |

...
},

| cellReselectionServingFreqInfo | SEQUENCE { | |
|---|---|---|
| s-NonIntraSearchP | ReselectionThreshold | OPTIONAL, -- Need S |
| s-NonIntraSearchQ | ReselectionThresholdQ | OPTIONAL, -- Need S |
| threshServingLowP | ReselectionThreshold, | |
| threshServingLowQ | ReselectionThresholdQ | OPTIONAL, -- Need R |
| cellReselectionPriority | CellReselectionPriority, | |
| cellReselectionSubPriority | CellReselectionSubPriority | OPTIONAL, -- Need R |

...
},

| intraFreqCellReselecionInfo | SEQUENCE { | |
|---|---|---|
| q-RxLevMin | Q-RxLevMin, | |
| q-RxLevMinSUL | Q-RxLevMin | OPTIONAL, -- Need R |
| q-QualMin | Q-QualMin | OPTIONAL, -- Need S |
| s-IntraSearchP | ReselectionThreshold, | |
| s-IntraSearchQ | ReselectionThresholdQ | OPTIONAL, -- Need S |
| t-ReselectionNR | T-Reselection, | |
| frequencyBandList | MultiFrequencyBandListNR-SIB | OPTIONAL, -- Need S |
| frequencyBandListSUL | MultiFrequencyBandListNR-SIB | OPTIONAL, -- Need R |
| p-Max | P-Max | OPTIONAL, -- Need S |
| smtc | SSB-MTC | OPTIONAL, -- Need S |
| ss-RSSI-Measurement | SS-RSSI-Measurement | OPTIONAL, -- Need R |
| ssb-ToMeasure | SSB-ToMeasure | OPTIONAL, -- Need S |

| | |
|---|---|
| deriveSSB-IndexFromCell | BOOLEAN, |

...,
[[

| | | |
|---|---|---|
| t-ReselectionNR-SF | SpeedStateScaleFactors | OPTIONAL -- Need N |

]],
[[

| | | |
|---|---|---|
| smtc2-LP-r16 | SSB-MTC2-LP-r16 | OPTIONAL, -- Need R |
| ssb-PositionQCL-Common-r16 | SSB-PositionQCL-Relation-r16 | OPTIONAL -- Cond |

SharedSpectrum
]],
[[

| | | |
|---|---|---|
| ssb-PositionQCL-Common-r17 | SSB-PositionQCL-Relation-r17 | OPTIONAL -- Cond |

SharedSpectrum2
]],
[[

| | | |
|---|---|---|
| smtc4list-r17 | SSB-MTC4List-r17 | OPTIONAL -- Need R |

]],
[[

| | | |
|---|---|---|
| frequencyBandList-v1760 | MultiFrequencyBandListNR-SIB-v1760 | OPTIONAL, -- Need R |
| frequencyBandListSUL-v1760 | MultiFrequencyBandListNR-SIB-v1760 | OPTIONAL -- Need R |

]],
[[

| | | |
|---|---|---|
| frequencyBandListAerial-r18 | MultiFrequencyBandListNR-Aerial-SIB-r18 | OPTIONAL -- Need S |

]]
},
...,
[[

| | |
|---|---|
| relaxedMeasurement-r16 | SEQUENCE { |
| lowMobilityEvaluation-r16 | SEQUENCE { |
| s-SearchDeltaP-r16 | ENUMERATED { |

dB3, dB6, dB9, dB12, dB15,
spare3, spare2, spare1},

| | |
|---|---|
| t-SearchDeltaP-r16 | ENUMERATED { |

s5, s10, s20, s30, s60, s120, s180,
s240, s300, spare7, spare6, spare5,
spare4, spare3, spare2, spare1}

| } | | OPTIONAL, -- Need R |
|---|---|---|
| cellEdgeEvaluation-r16 | SEQUENCE { | |
| s-SearchThresholdP-r16 | ReselectionThreshold, | |
| s-SearchThresholdQ-r16 | ReselectionThresholdQ | OPTIONAL -- Need R |
| } | | OPTIONAL, -- Need R |
| combineRelaxedMeasCondition-r16 | ENUMERATED {true} | OPTIONAL, -- Need R |
| highPriorityMeasRelax-r16 | ENUMERATED {true} | OPTIONAL -- Need R |

| | |
|---|---|
| } | OPTIONAL -- Need R |

]],
[[

| | | |
|---|---|---|
| cellEquivalentSize-r17 | INTEGER(2..16) | OPTIONAL, -- Cond HSDN |

| | |
|---|---|
| relaxedMeasurement-r17 | SEQUENCE { |
| stationaryMobilityEvaluation-r17 | SEQUENCE { |
| s-SearchDeltaP-Stationary-r17 | ENUMERATED {dB2, dB3, dB6, dB9, dB12, dB15, spare2, spare1}, |
| t-SearchDeltaP-Stationary-r17 | ENUMERATED {s5, s10, s20, s30, s60, s120, s180, s240, s300, spare7, spare6, |

spare5,
spare4, spare3, spare2, spare1}
},

| cellEdgeEvaluationWhileStationary-r17 | SEQUENCE { | |
|---|---|---|
| s-SearchThresholdP2-r17 | ReselectionThreshold, | |
| s-SearchThresholdQ2-r17 | ReselectionThresholdQ | OPTIONAL -- Need R |
| } | | OPTIONAL, -- Need R |
| combineRelaxedMeasCondition2-r17 | ENUMERATED {true} | OPTIONAL -- Need R |

| | |
|---|---|
| } | OPTIONAL -- Need R |

]]
}
RangeToBestCell := Q-OffsetRange

TABLE 2
Example parameters in SIB3 for cell (re)selection procedure

| SIB3 ::= | SEQUENCE { | |
|---|---|---|
| intraFreqNeighCellList | IntraFreqNeighCellList | OPTIONAL, -- Need R |
| intraFreqExcludedCellList | IntraFreqExcludedCellList | OPTIONAL, -- Need R |
| lateNonCriticalExtension | OCTET STRING | OPTIONAL, |

```
  ...,
  [[
```

| | | |
|---|---|---|
| intraFreqNeighCellList-v1610 | IntraFreqNeighCellList-v1610 | OPTIONAL, -- Need R |
| intraFreqAllowedCellList-r16 | IntraFreqAllowedCellList-r16 | OPTIONAL, -- Cond |

SharedSpectrum2

| | |
|---|---|
| intraFreqCAG-CellList-r16 | SEQUENCE (SIZE (1..maxPLMN)) OF IntraFreqCAG-CellListPerPLMN-r16 |

```
OPTIONAL -- Need R
  ]],
  [[
```

| | | |
|---|---|---|
| intraFreqNeighHSDN-CellList-r17 | IntraFreqNeighHSDN-CellList-r17 | OPTIONAL, -- Need R |
| intraFreqNeighCellList-v1710 | IntraFreqNeighCellList-v1710 | OPTIONAL -- Need R |

```
  ]],
  [[
```

| | | |
|---|---|---|
| channelAccessMode2-r17 | ENUMERATED {enabled} | OPTIONAL -- Need R |

]]
}

| IntraFreqNeighCellList ::= | SEQUENCE (SIZE (1..maxCellIntra)) OF IntraFreqNeighCellInfo | |
|---|---|---|
| IntraFreqNeighCellList-v1610 ::= | SEQUENCE (SIZE (1..maxCellIntra) OF IntraFreqNeighCellInfo-v1610 | |
| IntraFreqNeighCellList-v1710 ::= | SEQUENCE (SIZE (1..maxCellIntra) OF IntraFreqNeighCellInfo-v1710 | |
| IntraFreqNeighCellInfo ::= | SEQUENCE { | |
| physCellId | PhysCellId, | |
| q-OffsetCell | Q-OffsetRange, | |
| q-RxLevMinOffsetCell | INTEGER (1..8) | OPTIONAL, -- Need R |
| q-RxLevMinOffsetCellSUL | INTEGER (1..8) | OPTIONAL, -- Need R |
| q-QualMinOffsetCell | INTEGER (1..8) | OPTIONAL, -- Need R |

...
}

Herein, the term ‘evaluated parameter’ may be used interchangeably with ‘evaluated RSRP’, ‘evaluated RSRQ’, where the term evaluated may be interpreted as adjusted, computed, calculated, compensated, scaled, defined, determined, identified. As such, a WTRU may determine an evaluated parameter based on one or more measured values along with one or more compensation and/or scaling parameters (e.g., (pre) configured and/or indicated parameters). The WTRU may calculate the addition, subtraction, multiplication, and/or division of one or more measured values with one or more compensation and/or scaling parameters to determine the corresponding evaluated parameter.

Upon finding a suitable cell, based on criteria for a suitable cell, the WTRU may select the suitable cell as the serving cell. In an example, the WTRU may use one or more criteria to select a candidate cell as a suitable cell. The WTRU may determine the criteria based on one or more evaluated parameters. The WTRU may determine the evaluated parameters based on one or more of measured parameters, compensation values, scaling rules. In an example, the WTRU may determine the compensation values and/or scaling rules based on one or more configured and/or indicated offsets, parameters, configured values. In an example, the WTRU may be configured with, or determine any one or more of the following example parameters for determining criteria for a suitable cell. An example parameter is measured cell received level value. For example, the WTRU may measure the reference signal received power (RSRP), signal-to-noise and interference ratio (SINR), received signal strength indicator (RSSI) for one or more SS/PBCH blocks, reference signals, and/or channels. Another example parameter is measured cell quality value. For example, the WTRU may measure the reference signal received quality (RSRQ) for one or more SS/PBCH blocks, reference signals, and/or channels. Another example parameter is minimum required measured RX level and/or quality level in a cell. For example, a WTRU may receive, determine, or be configured with one or more parameters and/or offset values to determine the minimum required Rx level (e.g., in dBm) and/or minimum required quality level (e.g., dB) in the corresponding cell.

Another example parameter is compensation values. For example, the WTRU may receive, determine, or be configured with one or more parameters, offset, and/or scaling values that may be used upon receiving an indication, or based on WTRU determining based on one or more modes of operation, thresholds. Another example parameter is evaluated cell (re) selection Rx level value. For example, the WTRU may compute, evaluate, and/or calculate the received level value (e.g., in dB) based on one or more measured parameters and/or compensation and/or scaling values. In an example, the WTRU may calculate the evaluated cell (re) selection Rx level value (e.g., Srxlev) based on the measured cell received level value (e.g., Qᵣₓₗₑᵥₘₑₐₛ), the minimum required measured Rx level (e.g., Qᵣₓₗₑᵥₘᵢₙ and/or Q_{rxlevminoffset}), the compensation parameters (e.g., P_{compensation}), one or more temporary offset values (e.g., Qoffsetₜₑₘₚ) (e.g., Srxlev=Qᵣₓₗₑᵥₘₑₐₛ-(Qᵣₓₗₑᵥₘᵢₙ+Q_{rxlevminoffset})-P_{compensation}-Qoffsetₜₑₘₚ). As such, the WTRU may select the corresponding cell as one of the candidate suitable cells if the evaluated cell (re) selection Rx level value is higher than a (pre) configured threshold (e.g., Srxlev>0 for cell selection, or Srxlev>SintraSearchP or Srxlev>SnonIntraSearchP for intra-frequency and inter-frequency, respectively, cell reselection).

Another example parameter is evaluated cell (re) selection quality value. For example, the WTRU may compute, evaluate, and/or calculate the received quality value (e.g., in dB) based on one or more measured parameters and/or compensation and/or scaling values. In an example, the WTRU may calculate the evaluated cell (re) selection quality value (e.g., Squal) based on the measured cell quality value (e.g., Q_{qualmeas}), the minimum required quality level (e.g., Q_{qualmin} and/or Q_{qualminoffset}), one or more temporary offset values (e.g., Qoffsetₜₑₘₚ) (e.g., Squal=Q_{qualmeas}-(Q_{qualmin}+Q_{qualminoffset})−Qoffsetₜₑₘₚ). As such, the WTRU may select the corresponding cell as one of the candidate suitable cells if the evaluated cell (re) selection quality value is higher than a (pre) configured threshold (e.g., Squal>0, or Squal>SintraSearchQ, or Squal>SnonIntraSearchQ for intra-frequency and inter-frequency, respectively, cell reselection).

The WTRU may receive or be configured with one or more of the compensations and/or scaling parameters, values, settings, and/or rules as the criteria for cell (re) selection via implicit and/or explicit indications. The explicit indications may be via master information block (MIB) in corresponding SS/PBCH block, system information blocks (e.g., SIB1, SIB2, SIB3, SIB4), semi-static configuration (e.g., via RRC), dynamic indication (e.g., via MAC-CE and/or DCI). The WTRU may determine to use one or more compensation and/or scaling rules based on implicit indication, that is based on comparing one or more parameters with corresponding thresholds for example.

Cell ranking is described herein. Upon measuring and calculating the evaluated received power and/or evaluated quality value, a WTRU may perform cell ranking for all the cells (e.g., serving and neighbor cells) that the WTRU determined as the candidate suitable cells based on the cell selection criterion. For example, the WTRU may determine the cell ranking based on the calculating the R values using average RSRP results. One or more of the following may apply. The following parameters are non-limiting examples of the parameters that may be included in cell ranking calculation and measurement. One or more of these parameters may be included. Other parameters may be included. Rₛ=Q_{meas,s}+Q_{hyst}−Qoffsetₜₑₘₚ. Rₙ=Q_{meas,n}−Qoffset-Qoffsetₜₑₘₚ. Where, Rs and Rn correspond to the serving and neighbor cells, respectively. In an example, in the above equation, Q_{hyst} may represent the mobility aspects of the WTRU. Qoffset may be configured with different values for intra-frequency and inter-frequency cell (re)selections, and Qmeas may be the measured RSRP quantity used in cell (re) selection. The WTRU may reselect a new candidate cell, if the new cell has higher R value than the serving cell during a (pre) configured time interval.

As part of PRACH transmission, a WTRU may perform a RACH procedure for connecting to the selected cell, including sending PRACH preamble to the selected cell. The WTRU may calculate the PRACH UL power based on a determined, measured, or calculated pathloss, according to the measured RSRP based on one or more received RSs (e.g., SSB, CSI-RS) in addition to one or more of a preamble received target power (e.g., PREAMBLE_RECEIVED_TARGET_POWER). The WTRU may limit the power by a maximum power (e.g., Pcmax,c, which may also be represented by Pcmax,f,c.)

For example, a WTRU may determine a transmission power for a PRACH, P_{PRACH,b,f,c}(i), on active UL BWP b of carrier f of cell c based on DL RS for cell c in transmission occasion i as

$${P}_{PRACH , b , f , c} ( i ) = min \{ {P}_{CMAX , f , c} ( i ) , {P}_{PRACH , target , f , c} + P {L}_{b , f , c} \} \qquad Equation ( 1 )$$

where P_{CMAX,f,c} (i) may be a WTRU configured maximum output power for carrier f of cell c within transmission occasion i, P_{PRACH,target,f,c} may be the PRACH target reception power, PREAMBLE_RECEIVED_TARGET_POWER for the active UL BWP b of carrier f of cell c, and PL_{b,f,c} may a pathloss for the active UL BWP b of carrier f based on the DL RS associated with the PRACH transmission on the active DL BWP of cell c and may be calculated by the WTRU in dB as referenceSignalPower−higher layer filtered RSRP in dBm. The DL RS may be an SSB or a CSI-RS.

Herein, the terms UL muting, UL cancellation, protected symbols, reduced CLI, and reduced interference may be used interchangeably. For resource allocations for Uplink transmission (Tx) occasions, a WTRU may receive or be configured with one or more resource allocation settings for uplink transmission (e.g., channels and/or signals) in one or more Tx occasions. For example, for control uplink transmission (e.g., PUCCH), the resource allocation and/or configuration may include one or more settings and/or parameters, such as starting PRB, second hop starting PRB, number of PRBs, number of slots, starting symbol index, PUCCH format, cyclic shift, and/or OCC config, which may be indicated based on a PUCCH resource index and/or indicator (e.g., PUCCH-Resourceld).

In an example, for a downlink (shared) channel transmission (e.g., PDSCH) configured by semi-static indications (e.g., SPS PDSCH configured by SPS-Config), the WTRU may determine, receive, or be configured with associated PUCCH resource index and/or indicator to be used for sending corresponding control information (e.g., hybrid automatic repeat request acknowledgement (HARQ-ACK), CSI report). For example, the time resources (e.g., slot) for transmission of HARQ-ACK in respective PUCCH may be defined based on one or more RRC-configured parameters (e.g., K1 defined via di-DataToUL-ACK in PUCCH-Config in BWP-UplinkDedicated), and/or activated by DCI (e.g., format 1_1 or 1_2 with a value of PDSCH-to-HARQ_feedback timing indicator field).

In another example, for uplink shared channel transmission (e.g., PUSCH), the resource allocation and/or configuration may be indicated based on one or more settings and/or parameters, such as time resources (e.g., timeDomainAllocation), frequency resources (e.g., frequencyDomainAllocation), periodicity, and/or repetition. For example, for a PUSCH transmission corresponding to a first configured grant (e.g., Type 1) or for a PUSCH transmission corresponding to a second configured grant (e.g., Type 2) and activated (e.g., by DCI), the resource allocations are provided by one or more parameters (e.g., via ConfiguredGrantConfig in BWP-UplinkDedicated and/or activating UL grant received on the DCI). In another example, an FDRA may be indicated in the DCI indicating the multiple PUSCH transmissions (e.g., repetitions). The FDRA may be received via RRC configuration, such as in a configured grant configuration.

Moreover, the WTRU may receive a DCI (e.g., an UL grant DCI) scheduling a PUSCH. For a PUSCH transmission corresponding to an UL grant (e.g., dynamic-grant), the TDRA value (e.g., in DCI) may indicate the slot offset (e.g., K2 via indexed row), the start and length indicator (e.g., SLIV), or directly the start symbol and the allocation length, respective PUSCH mapping type, the number of slots used for TBS determination, and/or the number of repetitions for the PUSCH transmission.

Modes of operation in resources are used with UL muting. A WTRU may receive one or more indications, commands, and/or configuration information (e.g., from a gNB) on resources where the UL muting is taking place. Upon reception of the one or more indications, commands, and/or configuration information, the WTRU may determine the time and frequency resources where the WTRU cannot and/or should not transmit determined, configured, scheduled, and/or granted UL transmissions. In an example, the UL transmission occasions may include, but are not limited to: SRS, PRACH, configured PUSCH, dynamic grant PUSCH, PUSCH scheduled by non-fallback DCI formats (e.g., DCI formats 0_1 and 0_2), PUCCH, UCI, and/or HARQ-ACK. Based on the received configuration on the UL muting, the WTRU may also determine the time and frequency resources where other WTRUs may not transmit respective configured, scheduled, and/or granted UL transmissions.

In case the WTRU is configured with UL transmission that overlaps with the indicated time and frequency resources for UL muting, the WTRU may determine the mode of operation. The first mode of operation may be based on puncturing or performing rate-matching for the configured UL transmission that overlaps with the configured UL muting occasions. The second mode of operation may be based on dropping or not transmitting the configured UL transmission that overlaps with the configured UL muting occasions.

Herein, the terms resources, time and frequency resources, and occasions may be used interchangeably. In an example, in case the WTRU determines that puncturing the configured UL transmission may not require puncturing the DMRS symbols and/or REs, the WTRU may use the first mode of operation. Otherwise, in case the WTRU determines that puncturing the configured UL transmission may require puncturing the DMRS symbols and/or REs, the WTRU may use the second mode of operation. In case a WTRU is configured with UL muting in one or more resources and the WTRU is also configured and/or scheduled with one or more DL reception grants and/or occasions (e.g., SSB, PDCCH, PDSCH, CSI-RS, and/or phase tracking reference signal (PT-RS)), the WTRU may receive the configured and/or scheduled DL signals and/or channels based on the scheduled and/or configured configurations.

UL Muting Indications may be used. A WTRU may receive one or more indications, commands, and/or configuration information (e.g., from a gNB) on one or more UL muting occasions. In an example, the WTRU may receive UL muting command via dynamic configurations (e.g., via DCI). In another example, the WTRU may receive one or more configuration information on semi-static resources where UL muting may be configured (e.g., via MAC-CE, RRC, SIB, etc.). In another example, the WTRU may receive indications (e.g., via MAC-CE, DCI), where the indications may identify to activate, deactivate, enable, or disable a (pre) configured set of resources for UL muting.

A WTRU may receive indications on resources with UL muting based on one or more indication signals and/or channels. The indications may be cell-common, group-common, and/or WTRU-specific. The indications may be indicated via broadcasted signaling. The indications may be indicated semi-statically, dynamically, and/or via one-shot signaling. One or more of the following example indication signals and/or channels may be used.

An example indication signal is the Master Information Block (MIB). For example, the WTRU may receive configuration information on one or more time and frequency resources with UL muting via PBCH in MIB corresponding to a detected SSB. In an example, the configuration may indicate resources where the UL muting may happen. The indication may indicate if the UL muting may take place periodically, semi-persistently, or a-periodically, based on one or more events, parameters, and/or configurations. The indicated resources for UL muting may be cell-common, group-common, event-based, and/or WTRU-specific.

Another example indication signal is the System Information Block (SIB). For example, the WTRU may receive configuration information on one or more time and frequency resources with UL muting via SIB1, and/or SIB2. In an example, the configuration may indicate semi-static resources where the UL muting may happen. The indication may indicate if UL muting may take place periodically, semi-persistently, or a-periodically, based on one or more events, parameters, and/or configurations. The indicated resources for UL muting may be cell-common, group-common, event-based, and/or WTRU-specific. Another example indication signal is the PDCCH indication. For example, the WTRU may monitor and detect search spaces for PDCCH detection in corresponding common search spaces (CSS), where the CSS may be for example one or more of Type 1 common CSS without dedicated RRC configuration, such as Type 0, 0A, and 2 CSS, one or more of Type 1 common CSS with dedicated RRC configuration, such as Type 3 CSS and WTRU specific search space. The WTRU may receive one or more configuration information on one or more time and frequency resources with UL muting via PDCCH indication.

Another example indication signal is RRC Indication. For example, the WTRU may receive one or more configuration information on one or more time and frequency resources with UL muting via RRC signaling. Another example indication signal is MAC-CE Indication. For example, the WTRU may receive one or more configuration information on one or more time and frequency resources with UL muting via MAC-CE signaling. Another example indication signal is DCI indication. For example, the WTRU may receive one or more group DCI (e.g., DCI format 2_0, 2_1, etc.) and/or WTRU-specific DCI (e.g., DCI format 0_0, 0_1, 1_0, 1_1, etc.) indications. In an example, the WTRU may receive one or more (e.g., dynamic) UL muting commands and indications including configuration information on one or more resources for UL muting via DCI. In another example, the WTRU may receive one or more UL muting commands and indications including indications and references to activate, enable, deactivate, and/or disable one or more (pre) configured resources for UL muting via DCI. Another example indication signal is Paging indications. For example, the WTRU may monitor and detect one or more paging occasions to receive one or more paging indications. The WTRU may receive one or more configuration information on one or more time and frequency resources with UL muting via paging indications.

In the above-mentioned examples of indication signals and/or channels, the indicated resources for UL muting may be cell-common, group-common, event-based, and/or WTRU-specific. In an example, the indicated resources for UL muting may be cell-common, that is all the WTRUs that are camped-on and/or connected to the corresponding cell should perform UL muting in the indicated resources. In another example, the indicated resources for UL muting may be group-common, that is the UL muting in the indicated resources must be performed only by the WTRUs that belong to a configured and/or indicated group, or the WTRUs that are indicated via one or more corresponding groups' signaling. For example, the group-common UL-muting command and/or indication may be based on an event detected at the gNB and/or the configured group of WTRUs. In another example, the indicated resources for UL muting may be event-based, that is UL muting in the indicated resources must be applied only by the WTRUs that have triggered one or more configured events. In another example, the indicated resources for UL muting may be WTRU-specific, that is UL muting in the indicated resources must be applied only by the WTRUs that have received corresponding indications.

Indications of time and frequency resources may be used for UL muting. A WTRU may receive or be configured with one or more time and frequency resources where the UL muting is configured, scheduled, and/or indicated. In an example, the indication may include one or more of the following configuration information. An example of configuration information is time resources. For example, the WTRU may receive or be configured with the time resources where the UL muting is configured. In an example, the WTRU may receive the configured time resources based on one or more of the following: exact time; and/or based on configured gaps or offsets. For Exact time for example, the WTRU may receive the starting time instance (e.g., symbol, slot, subframe, etc.) the ending time instance, or the time duration during which the UL muting is configured. The time duration may be indicated based on time units (e.g., us, ms, seconds, etc.), or based on time instances (e.g., symbols, slots, subframes, etc.). For example, the WTRU may receive configurations on an UL muting occasion that is configured with starting symbol #1 and ending symbol #5. In another example, the WTRU may receive configurations on an UL muting occasion that is configured with starting symbol #1 and duration of four symbols. For example, the indication may indicate that starting in I-ms, the UL muting takes place for t-ms. For configured gaps and/or offsets for example, the WTRU may receive or be configured with an exact time instance in addition to one or more time gap or time offset values. As such, the WTRU may use the configured time gaps before and/or after the configured exact time instance to determine the time when the UL muting is configured. For example, the WTRU may receive configurations on an UL muting occasion that is configured at symbol #3 with 2-symbols before and after gaps (i.e., that implies symbol #1-#5).

Another example of configuration information is Periodicity. For example, the WTRU may receive or be configured with one or more periodicity types for the configured UL muting occasions. In an example, the WTRU may be configured with one or more periodic UL muting occasions where the time period is indicated and/or configured for the WTRU. In another example, the WTRU may be configured with one or more semi-persistent UL muting occasions where the duration for which the UL muting is taking place is indicated and/or configured for the WTRU. In another example, the WTRU may be configured with one or more aperiodic UL muting occasions, for example in one-shot UL muting for a configured time duration, starting from an indicated time instance.

Another example of configuration information is frequency resources. For example, the WTRU may receive or be configured with the frequency resources where the UL muting is configured. The WTRU may be configured with the frequency resources based on one or more of the following example factors: UL RBs, UL PRBs, UL RBGs, UL PRGs, UL Subbands, UL BWPs, and/or UL Sub-BWPs. In an example, the WTRU may receive the configured time resources based on one or more of the following: entire UL boundaries; and or limited UL RBs. For Entire UL boundaries for example, the WTRU may be configured with one or more UL muting occasions, where the UL muting is configured in the entire configured and/or indicated UL RBs, UL PRBs, UL RBGs, UL PRGs, UL subbands, UL BWPs, UL sub-BWPs, etc. That is, the WTRU must not transmit UL in the entire configured UL frequency boundaries and also may expect other configured WTRUs to not transmit in the entire configured UL frequency boundaries. For Limited UL RBs for example, the WTRU may be configured with one or more UL muting occasions, where the UL muting is configured in one or more (e.g., limited) RBs or RB sets within the configured UL frequency boundaries. In an example, the WTRU may determine, receive, or be configured with a number of RBs, or RB sets where the UL muting is configured. For example, the configured number of RBs may be the RBs close to the band edge of the configured UL boundaries. In an example, the WTRU may explicitly receive or be (pre) configured with the number of RBs where UL muting may take place. In another example, the WTRU may determine the number of RBs based on a (pre) configured, determined, or indicated function and/or one or more parameters.

Beam nulling may be used. A WTRU may receive one or more indications, commands, and/or configuration information (e.g., from a gNB) on resources where the beam nulling is taking place. In an example, upon reception of the one or more indications, commands, and/or configuration information, the WTRU may determine the beam directions (e.g., TCI-states) in addition to time and frequency resources where the WTRU cannot and/or should not transmit determined, configured, scheduled, and/or granted UL transmissions. In another example, upon reception of the one or more indications, commands, and/or configuration information, the WTRU may determine the beam directions (e.g., TCI-states) in addition to the time and frequency resources where the WTRU may not expect receiving any configured, scheduled, and/or granted DL receptions.

In an example, the UL transmission occasions may include, but are not limited to, any of the following example transmission occasions: SRS, PRACH, configured PUSCH, dynamic grant PUSCH, PUSCH scheduled by non-fallback DCI formats (e.g., DCI formats 0_1 and 0_2), PUCCH, UCI, and/or HARQ-ACK. In an example, the DL reception occasions may include, but are not limited to, any of the following example transmission occasions: SSB, CSI-RS, PDCCH, PDSCH, reference signals, PT-RS, and/or PRS. Based on the received configuration on the beam nulling, the WTRU may also determine the beam directions (e.g., TCI-states) and the time and frequency resources where other WTRUs may not transmit or receive respective configured, scheduled, and/or granted UL or DL, respectively.

In case the WTRU is configured with UL transmission in the beam directions (e.g., TCI-states) that overlaps with the indicated time and frequency resources and the indicated beam directions for beam nulling, the WTRU may determine the mode of operation. The first mode of operation may be based on puncturing or performing rate-matching for the configured UL transmission that overlaps with the configured beam nulling occasions. The second mode of operation may be based on dropping or not transmitting the configured UL transmission that overlaps with the configured beam nulling occasions. In an example, in case the WTRU determines that puncturing the configured UL transmission may not require puncturing the DMRS symbols and/or REs, the WTRU may use the first mode of operation. Otherwise, in case the WTRU determines that puncturing the configured UL transmission may require puncturing the DMRS symbols and/or REs, the WTRU may use the second mode of operation.

Beam Nulling Indication may be used. A WTRU may receive one or more indications, commands, and/or configuration information (e.g., from a gNB) on one or more beam nulling occasions. In an example, the WTRU may receive beam nulling command via dynamic configurations (e.g., via DCI). In another example, the WTRU may receive one or more configuration information on semi-static resources where beam nulling may be configured (e.g., via MAC-CE, RRC, and/or SIB). In another example, the WTRU may receive indications (e.g., via MAC-CE, DCI), where the indications may identify to activate, deactivate, enable, or disable a (pre) configured set of resources and/or beam directions (e.g., TCI-states) for beam nulling. A WTRU may receive indications on resources with beam nulling based on one or more indication signals and/or channels. The indications may be cell-common, group-common, and/or WTRU-specific. The indications may be indicated via broadcasted signaling. The indications may be indicated semi-statically, dynamically, and/or via one-shot signaling. The WTRU may receive the beam nulling indications (e.g., via MIB, SIB, paging indications, RRC, MAC-CE, and/or DCI).

Indication of time and frequency resources may be used for beam nulling. A WTRU may receive or be configured with one or more time and frequency resources where the beam nulling is configured, scheduled, and/or indicated for one or more beam directions (e.g., TCI-states). In an example, the indication may include one or more of the following example information. Example information may indicate beam directions (e.g., TCI-states). For example, the WTRU may receive, be configured, and/or indicated with the beam directs for which the beam nulling may be configured. In an example, the WTRU may receive the configured beam directions based on one or more of the following: beam indexes; beam group identifier (ID); and/or set of beam indexes.

For beam indexes for example, the WTRU may receive one or more explicit beam indexes to be muted and/or nulled during the beam nulling occasion. For Beam group ID for example, the WTRU may receive one or more beam group ID to be muted and/or nulled during the beam nulling occasion. The WTRU may be (pre) configured and/or indicated with one or more beam groups and respective beam group IDs, where each beam group may include one or more beam indexes. As such, upon reception the indication on the beam group ID, the WTRU may consider the beam nulling for all beam indexes included in the indicated beam group ID. For set of beam indexes for example, the WTRU may receive one or more sets of beam indexes to be muted and/or nulled during the beam nulling occasion. The sets of beam indexes may be indicated via a starting beam index and an ending beam index. The WTRU may consider the beam nulling for all beam indexes included in between the indicated starting and ending beam indexes.

Example information may indicate time resources. For example, the WTRU may receive or be configured with the time resources where the beam nulling is configured. In an example, the WTRU may receive the configured time resources based on one or more of the following: exact time; and/or based on configured gaps and/or offsets.

For exact time for example, the WTRU may receive the starting time instance (e.g., symbol, slot, subframe, etc.) the ending time instance, or the time duration during which the beam nulling is configured. The time duration may be indicated based on time units (e.g., us, ms, seconds, etc.), or based on time instances (e.g., symbols, slots, subframes, etc.). For example, the WTRU may receive configurations on a beam nulling occasion that is configured with starting symbol #1 and ending symbol #5. In another example, the WTRU may receive configurations on a beam nulling occasion that is configured with starting symbol #1 and duration of four symbols. For example, the indication may indicate that starting in I-ms, the beam nulling takes place for t-ms. For based on configured gaps and/or offsets for example, the WTRU may receive or be configured with an exact time instance in addition to one or more time gap or time offset values. As such, the WTRU may use the configured time gaps before and/or after the configured exact time instance to determine the time when the beam nulling is configured. For example, the WTRU may receive configurations on a beam nulling occasion that is configured at symbol #3 with 2-symbols before and after gaps (i.e., that implies symbol #1-#5).

Example information may indicate periodicity. For example, the WTRU may receive or be configured with one or more periodicity types for the configured beam nulling occasions. In an example, the WTRU may be configured with one or more periodic beam nulling occasions where the time period is indicated and/or configured for the WTRU. In another example, the WTRU may be configured with one or more semi-persistent beam nulling occasions where the duration for which the beam nulling is taking place is indicated and/or configured for the WTRU. In another example, the WTRU may be configured with one or more aperiodic beam nulling occasions, for example in one-shot beam nulling for a configured time duration, starting from an indicated time instance.

Example information may indicate frequency resources. For example, the WTRU may receive or be configured with the frequency resources where the beam nulling is configured. The WTRU may be configured with the frequency resources based on one or more of RBs, PRBs, RBGs, PRGs, Subbands, BWPs, Sub-BWPs, etc. In an example, the WTRU may receive the configured time resources based on one or more of the following: entire UL or DL boundaries; and/or limited UL or DL RBs. For entire UL or DL boundaries for example, the WTRU may be configured with one or more beam nulling occasions, where the beam nulling is configured in the entire configured and/or indicated UL or DL frequencies. That is, the WTRU must not transmit UL or receive DL in the entire configured UL or DL frequency boundaries. In an example, the WTRU may also expect other configured WTRUs to not transmit or receive in the entire configured UL or DL frequency boundaries. For limited UL or DL RBs for example, the WTRU may be configured with one or more beam nulling occasions, where the beam nulling is configured in one or more (e.g., limited) RBs or RB sets within the configured UL or DL frequency boundaries. In an example, the WTRU may determine, receive, or be configured with a number of RBs, or RB sets where the beam nulling is configured. For example, the configured number of RBs may be the RBs close to the band edge of the configured UL or DL boundaries. In an example, the WTRU may explicitly receive or be (pre) configured with the number of RBs where UL or DL beam nulling may take place. In another example, the WTRU may determine the number of RBs based on a (pre) configured, determined, or indicated function and/or one or more parameters.

New Radio (NR) duplex operation may provide a foundation in improving conventional time-division duplexing (TDD) operation by enhancing UL coverage, improving capacity, reducing latency. Conventional TDD operation is based on splitting the time domain between the uplink and downlink. Full duplex, or more specifically, sub-band non-overlapping full duplex (SBFD) at the gNB within a conventional TDD band, may be used (e.g., in NR R19). FIG. 2 is a frame format diagram illustrating an example TDD framework 200 with SBFD configuration. The TDD framework 200 includes downlink (DL) slot 202 for DL transmissions, flexible slot 204 for uplink or downlink transmissions, and uplink (UL) slot 206 for UL transmission. Transmissions in the DL slot 202, flexible slot 204, and UL slot 206 use the entire frequency band. The transmission in SBFD slots 208 use subbands of the frequency band for transmissions. Specifically, DL transmissions are sent in DL subbands 210, and UL transmissions are sent in UL subbands 212.

A WTRU in RRC-Idle/Inactive State may perform cell (re) selection by calculating a cell ranking value based on a measured received power (e.g., reference signal received power (RSRP) and one or more offset and/or threshold values. The WTRU may monitor, detect, receive, and/or measure one or more synchronization signal blocks (SSBs) from one or more neighboring (e.g., non-serving) cells. The WTRU may receive configurations for the neighboring cells to monitor and receive SSBs, for example via a system information block (SIB) received from the serving cell. For example, the WTRU may calculate the cell ranking values based on measured RSRP and/or the calculated cell ranking value for the serving cell, Rs, and the calculated cell ranking value for the neighbor cell(s), Rn. For example, Rs=Qmeas,s+Qhyst-Qoffsettemp, and Rn=Qmeas,n−Qoffset-Qoffsettemp, such that parameter Qhyst may represent the mobility aspects of the WTRU, parameter Qoffset may represents the offset values for intra-frequency and inter-frequency cell (re)selections, and parameter Qmeas may be the measured RSRP quantity used in cell (re) selection.

According to an example layer 1/layer 2 (L1/L2) Triggered Mobility (LTM) LTM procedure (also referred to as a lower layer triggered mobility procedure), a gNB may receive L1 measurement report(s) from a WTRU, and based on the L1 measurement report(s) the gNB may change the WTRU's serving cell, for example by sending a cell switch command signaled via a Medium Access Control (MAC) Control Element (MAC CE). The cell switch command may indicate an LTM candidate configuration that the gNB previously prepared and provided to the WTRU through radio resource control (RRC) signaling. The WTRU may switch to the target configuration according to the cell switch command. The LTM procedure may be used to reduce the mobility latency.

When configured by the network, Transmission Configuration Indication (TCI) states of one or multiple cells may be activated that are different from the current serving cell. For example, the TCI states of the LTM candidate cells may be activated in advance before any of those cells become the serving cell. This allows the WTRU to be DL synchronized with those cells, thereby facilitating a faster cell switch to one of those cells when cell switch is triggered.

The LTM channel state information (CSI) report configuration may be used to configure CSI report on the cell in which the LTM-CSI-ReportConfig information element (IE) is included. The LTM-CSI-ResourceConfig IE may indicate a list of synchronization signal blocks (SSBs) or Channel State Information-Reference Signal (CSI-RS) resources for LTM CSI measurement and reporting. Example configured parameters (e.g., as in NR Release 18) that may be included in the LTM-CSI-ReportConfig information element are provided in Table 3. Table 3 is a non-limiting example of the parameters that may be included in LTM CSI report configuration. One or more of those parameters may be included. The number of bits and choices for each parameter are examples. Other numbers of bits or choices may be used.

TABLE 3
LTM-CSI-ReportConfig information element including example of SBFD configuration in TDD framework

-- ASN1START
-- TAG-LTM-CSI-REPORTCONFIG-START

| | |
|---|---|
| LTM-CSI-ReportConfig-r18 ::= | SEQUENCE { |
| ltm-CSI-ReportConfigId-r18 | LTM-CSI-ReportConfigId-r18, |
| ltm-ResourcesForChannelMeasurement-r18 | LTM-CSI-ResourceConfigId-r18, |
| ltm-ReportConfigType-r18 | CHOICE { |
| periodic-r18 | SEQUENCE { |
| reportSlotConfig-r18 | CSI-ReportPeriodicityAndOffset, |
| pucch-CSI-ResourceList-r18 | SEQUENCE (SIZE (1..maxNrofBWPs)) OF PUCCH-CSI-Resource |

},

| | |
|---|---|
| semiPersistentOnPUCCH-r18 | SEQUENCE { |
| reportSlotConfig-r18 | CSI-ReportPeriodicityAndOffset, |
| pucch-CSI-ResourceList-r18 | SEQUENCE (SIZE (1..maxNrofBWPs)) OF PUCCH-CSI-Resource |

},

| | |
|---|---|
| semiPersistentOnPUSCH-r18 | SEQUENCE { |
| reportSlotConfig-r18 | CSI-ReportPeriodicityAndOffset, |
| reportSlotOffsetList-r18 | SEQUENCE (SIZE (1..maxNrofUL-Allocations-r16)) OF INTEGER |

(0..128),

| | |
|---|---|
| reportSlotOffsetListDCI-0-2-r18 | SEQUENCE (SIZE (1..maxNrofUL-Allocations-r16)) OF INTEGER |

(0..128),

| | |
|---|---|
| reportSlotOffsetListDCI-0-1-r18 | SEQUENCE (SIZE (1..maxNrofUL-Allocations-r16)) OF INTEGER |

(0..128),

| | |
|---|---|
| p0alpha | P0-PUSCH-AlphaSetId |

},

| | |
|---|---|
| aperiodic-r18 | SEQUENCE { |
| reportSlotOffsetList-r18 | SEQUENCE (SIZE (1..maxNrofUL-Allocations-r16)) OF INTEGER |

(0..128),

| | |
|---|---|
| reportSlotOffsetListDCI-0-2-r18 | SEQUENCE (SIZE (1..maxNrofUL-Allocations-r16)) OF INTEGER |

(0..128),

| | |
|---|---|
| reportSlotOffsetListDCI-0-1-r18 | SEQUENCE (SIZE (1..maxNrofUL-Allocations-r16)) OF INTEGER |

```
(0..128)
    },
    ...
  },
```

| | |
|---|---|
| ltm-ReportContent-r18 | LTM-ReportContent-r18, |

...
}

| LTM-ReportContent-r18 ::= | SEQUENCE { | |
|---|---|---|
| nrOfReportedCells-r18 | ENUMERATED {n1,n2,n3,n4}, | |
| nrOfReportedRS-PerCell-r18 | ENUMERATED {n1,n2,n3,n4}, | |
| spCellInclusion-r18 | ENUMERATED {true} | OPTIONAL -- Need R |

}
-- TAG-LTM-CSI-REPORTCONFIG-STOP
-- ASN1STOP

Progress has been made with regards to SBFD systems, including the following example agreements and assumptions being made in 3GPP RAN1. Under an example working assumption, for SSB symbols configured with SBFD subbands, an option is that the SSB symbols configured with SBFD subbands are SBFD symbols. In this case, only DL receptions within DL usable Physical Resource Blocks (PRBs) may be allowed for SBFD aware WTRUs. The SSB block may be assumed to be within the DL subband.

In an example agreement, for L1 WTRU-to-WTRU cross-link interference (CLI) measurement and reporting, CLI measurements may be performed within the active DL BWP and the following are supported. In an example method, the WTRU may measure Received Signal Strength Indicator (RSSI) within DL subband (Method #1). In another example method, the WTRU may measure Reference Signal Received Power (RSRP) of aggressor WTRU within UL subband (Method #2). In another example method, the WTRU may measure RSSI within UL subband ((Method #3).

In an example agreement, for L1 WTRU-to-WTRU CLI measurement and reporting, the WTRU measuring RSSI within UL subband (Method #3) is supported. A WTRU may not be configured to perform measurement using Method #1 and Methods #3 in the same OFDM symbol. Measurement resource(s) corresponding to Methods #1 and #3 shall not be associated with the same CSI-ReportConfig.

In an example agreement, a new IE SRS-RSRP-MeasurementResourceSet may be defined containing a set of SRS-RSRP measurement resource(s) SRS-RSRP-MeasurementResource for L1 SRS-RSRP measurement.

Configuration of slot offset between the slot containing the downlink control information (DCI) that triggers a set of aperiodic SRS-RSRP resources and the slot in which the SRS-RSRP resource set may be measured. SRS-RSRP-MeasurementResource may be defined with the following parameters: Legacy sounding reference signal (SRS) Resource IE; and/or other parameters.

In an example agreement, a new IE CLI-RSSI-MeasurementResourceSet may be defined containing a set of CLI-RSSI measurement resource CLI-RSSI-MeasurementResource for L1 CLI-RSSI measurement. Configuration of the slot offset between the slot containing the DCI that triggers a set of aperiodic CLI-RSSI resources and the slot in which the CLI-RSSI resource set may be measured. CLI-RSSI-MeasurementResource may be defined with the following parameters: CLI-RSSI measurement resource identifier (ID); starting PRB index; number of PRBs; starting symbol of the CLI-RSSI resource within a slot; number of symbols of the CLI-RSSI resource within a slot; periodicity and slot offset for the CLI-RSSI resource; and/or other parameters.

Progress has been made with regards to L1/L2 Triggered Mobility (LTM) systems, with the following example agreements and assumptions being made in 3GPP RAN2. In an example agreement, an event triggered L1 measurement may be designed for the following LTM purposes: select the candidate beam/cell to trigger early synchronization; and/or select the target beam/cell and trigger LTM cell switch procedure.

In an example agreement, support the following LTM events based on beam specific quality of serving cell and candidate cells as the L1 LTM measurement events: Event LTM2: beam of serving cell becomes worse than absolute threshold; event LTM3: Beam of candidate cell becomes amount of offset better than beam of serving cell; event LTM4: Beam of candidate cell becomes better than absolute threshold; and/or event LTM5: Beam of serving cell becomes worse than absolute threshold1 AND Beam of candidate cell becomes better than another absolute threshold2.

In an example agreement, the beam config of both SSB and CSI-RS in L1 measurement resource configuration may be supported in LTM config. 1n an example working assumption, a Same RS type may be used for both serving cell and neighboring cell for event LTM3 and event LTM5.

In NR Release 18, the cell (re) selection procedure may be based on measured RSRP of received SSBs from the serving cell compared to measured RSRP of received SSB from one or more non-serving (neighbor) cells. In full-duplex (FD) systems (e.g., SBFD systems), the cell selection and calculation of cell ranking may be affected by gNB-to-gNB or WTRU-to-WTRU CLI. The CLI may be from WTRU s in the serving cell or WTRU s in the candidate neighbor cells. In case the source of CLI is not detected, the unwanted CLI may cause the WTRU to select a sub-optimal cell degrading the performance in cell (re) selection procedure.

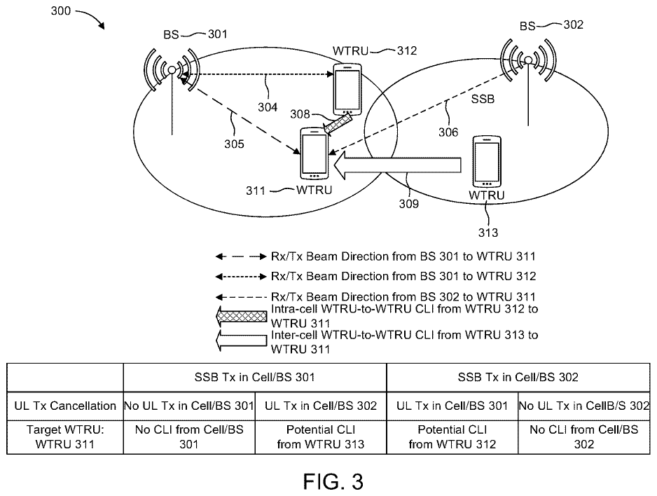

In an NR Release 19 work item on SBFD operation, it was agreed that for a specific cell that supports SBFD configurations, there will be no UL transmission in the symbols overlapping with SSB transmissions. That is, a WTRU measuring RSRP based on SSBs from the WTRU's serving cell may expect that no UL transmission is scheduled in the serving cell, and thus no CLI from the WTRUs in the serving cell. However, in this case, the WTRU may still receive inter-cell WTRU-to-WTRU CLI from a WTRU in a neighbor cell, as shown in an example scenario in FIG. 3.

FIG. 3 is a system diagram illustrating an example radio access network (RAN) 300 illustrating an example scenario of WTRU-to-WTRU CLI in LTM systems. In the example scenario, WTRU 311 and WTRU 312 perform transmission and reception (Tx/Rx) 305 and 304 with base station (BS) 301 (e.g., gNB) as their serving cell. WTRU 313 performs Tx/Rx with BS 302 (e.g., gNB) as its serving cell. WTRU 313 in BS/cell 302 may cause inter-cell WTRU-to-WTRU CLI 309 for WTRU 311 when WTRU 313 is transmitting to BS/cell 302 during an SSB transmission from BS/cell 301 to WTRU 311. In another example, a WTRU (e.g., WTRU 311) measuring RSRP based on SSBs from a neighbor cell (e.g. BS/cell 302) expects that no UL is scheduled in the neighbor cell during SSB transmission, and thus is not subjected to CLI from the WTRUs in the neighbor cell. However, a WTRU may still receive intra-cell WTRU-to-WTRU CLI from a WTRU in its own serving cell. For example, with reference to FIG. 3, WTRU 312 in BS/cell 301 may cause intra-cell WTRU-to-WTRU CLI 308 for WTRU 311 when WTRU 311 is performing SSB measurements based on SSBs transmitted by BS/cell 302 (i.e., a neighbor cell).

Accordingly, procedures and techniques disclosed herein may be used to enhance the cell (re) selection procedure in the existence of CLI. In an example, in accordance with the embodiments disclosed herein, procedures for CLI mitigation for LTM cell switching or cell (re) selection FD systems are described herein. In an example, it may be assumed that in SBFD systems, for SSB symbols configured with SBFD subbands, only DL receptions within DL usable PRBs are allowed for SBFD-aware WTRUs and no UL is transmitted. It may be assumed that SSB transmission in neighbor cells are not at the same time. It may be assumed that there is synchronization between cells (e.g., via backhaul). In an example scenario, a first WTRU may use a second beam direction to perform measurements based on SSBs from a second gNB (e.g., for the purpose of cell (re) selection). Using second beam direction may put the first WTRU at risk of WTRU-to-WTRU CLI from a second WTRU. The CLI may affect the SSB measurements and may result in lower measured SSBs' RSRP. This CLI may prevent the first WTRU from calculating the cell ranking correctly or selecting the best cell for cell (re) selection. The embodiments described provide solutions for how a WTRU may determine the best cell in cell (re) selection procedure despite WTRU-to-WTRU CLI.

In an example embodiment, a WTRU may measure SSBs received from a candidate non-serving cell and may determine to measure signal quality (e.g., RSRP, RSRQ, SINR) based on a first set of SSB bursts (of a first type) or a second set of SSB bursts (of a second type) based on one or more conditions (e.g., CLI). The second set of SSB bursts may be “clean” SSBs (the second type) during which no UL Tx is performed in the WTRU's serving cell. The WTRU may measure CLI-RSSI (e.g., in UL SB) in the SSB symbols from the first SSB burst, and if the measured CLI-RSSI is higher than a threshold, the WTRU may select to use the second SSB burst for measurements. The WTRU measuring the second SSB burst from the second cell, during which there is no UL Tx in WTRU's serving cell, has the benefit of improving the accuracy of calculated cell ranking from the second cell.

In an example embodiment, a WTRU (e.g., in Idle/Inactive mode performing cell (re) selection may receive an SSB burst from its first serving cell (e.g., last cell to which the WTRU was connected to). The WTRU may measure RSRP from the first (serving) cell and may calculate cell ranking value (Rs) for the serving cell. The WTRU may receive information (e.g., parameters, thresholds, etc.) for performing measurements and calculating cell ranking value (e.g., via SIB received from the serving cell). Example configuration information may include: configuration information on a first set of SSB bursts from a second (neighboring) cell with a first periodicity (e.g., every 20 ms); configuration information on a second set of SSB bursts from the second cell with a second periodicity (e.g., every 320 ms), during which no UL Tx is performed in the first cell (e.g., “clean” SSB). The “clean” SSB burst may indicate the periodicity of SSB bursts from the second (neighbor) cell, during which the first cell does not schedule UL Tx.

The WTRU may receive and measure (e.g., SS-RSRP) on one or more first SSB bursts from the second cell. The WTRU may measures CLI-RSSI (e.g., in the UL subband). The WTRU may receive and measure (e.g., SS-RSRP) on one or more first SSB bursts from the second cell in the same symbol as the SSB symbols in the first SSB bursts. If the measured CLI-RSSI is higher than a threshold, the WTRU may select one or more clean SSB bursts for measuring SS-RSRP and calculating cell ranking (Rn) value from the second cell. The WTRU may select the cell with the highest calculated cell ranking value and may send PRACH transmission to the selected cell if the WTRU decides to switch to the RRC-Connected State. In an example, after connecting to the selected cell, the WTRU may report the measured CLI-RSSI and/or may send an indication that the cell ranking was based on clean SSB burst.

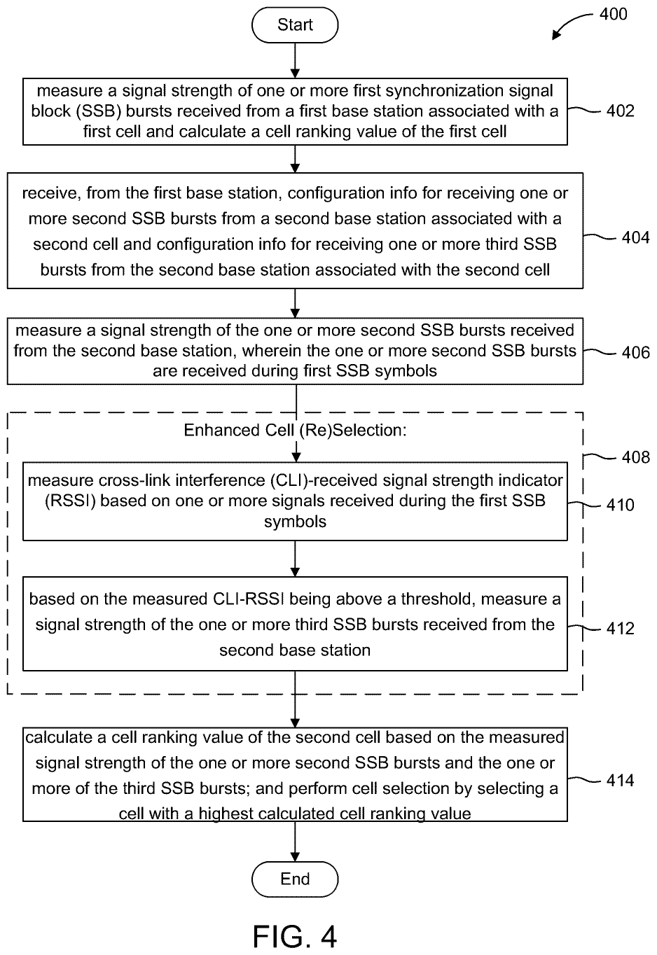

FIG. 4 is flow diagram illustrating an example enhanced cell (re) selection procedure 400 in the presence of WTRU-to-WTRU CLI, that may be performed by a WTRU in an SBFD system. At 402, the WTRU may measure a signal strength of one or more first synchronization signal block (SSB) bursts received from a first base station associated with a first cell (e.g., the serving cell of the WTRU) and may calculate a cell ranking value of the first cell. At 404, the WTRU may receive, from the first base station, configuration information for receiving one or more second SSB bursts from a second base station associated with a second cell and configuration information for receiving one or more third SSB bursts from the second base station associated with the second cell. In an example, the one or more second SSB bursts are of a first type and the one or more third SSB bursts are of a second type (first and second type may be same or different) and/or the third SSB bursts have a different periodicity than the second SSB bursts (alternatively, the periodicities may be the same). At 406, the WTRU may measure a signal strength of the one or more second SSB bursts received from the second base station, wherein the one or more second SSB bursts are received during first SSB symbols. Steps 410 and 412 may be considered part of an enhanced cell (re) selection procedure 408. At 410, the WTRU may measure cross-link interference (CLI)-received signal strength indicator (RSSI) based on one or more signals received during the first SSB symbols. In an example, the CLI-RSSI may be measured in one or more uplink subbands. At 412, based on the measured CLI-RSSI being above a threshold, the WTRU may measure a signal strength of the one or more third SSB bursts received from the second base station. At 414, the WTRU may calculate a cell ranking value of the second cell based on the measured signal strength of the one or more second SSB bursts and the measured signal strength of the one or more third SSB bursts. The WTRU may perform cell selection by selecting a cell with a highest calculated cell ranking value. Although not shown in FIG. 4, steps 404-412 may be repeated with additional neighboring cells, such that the cell ranking value may be calculated for the additional neighboring cells and the selection of a cell with highest calculated cell ranking value in step 414 is based on all neighboring cells for which SSB measurements and cell ranking calculations were made.

Procedures for enhanced cell selection are disclosed herein. In a full duplex (e.g., SBFD) system, the potential effect of WTRU-to-WTRU and/or gNB-to-gNB CLI should be considered in cell switching and/or cell (re) selection procedures. The WTRU may need to mitigate the CLI in the serving cell and/or the candidate and/or target cells as part of the procedure. In an example, if the CLI in the serving cell is affecting and/or interfering with the measurements based on signals and/or channels received from the candidate cell, the interference may cause inaccurate evaluation of the LTM events, resulting in WTRU staying in or selecting a suboptimal cell for switching that is not the best candidate cell. The benefit for CLI mitigation during LTM cell switching procedure is that the WTRU may evaluate LTM events accurately and perform the cell switching to the best candidate cell. Also, identifying the CLI effects before cell switch may provide benefits to avoid “ping-pong” effects (i.e., switching back and forth between cells) due to frequent cell switching.

In another example, if the CLI in the serving cell is affecting and/or interfering with the measurements based on signals and/or channels received from the candidate cell, the interference may cause inaccurate evaluation of the cell ranking values as part of cell (re) selection procedure, resulting in WTRU staying in or selecting a suboptimal cell that is not the best candidate cell. The benefit for CLI mitigation during cell (re) selection procedure is that the WTRU may evaluate cell ranking values accurately and select the best candidate cell. On the other hand, a WTRU may be configured and/or indicated that there may be no UL transmission in the symbols that overlap with SSB symbols in the corresponding cell. That is, the WTRUs operating based on SBFD operation may be configured to drop one or more configured and/or indicated UL transmissions in (e.g., UL subband of) SBFD symbols that overlap (e.g., in time) with SSB transmissions in the corresponding cell. In an example, when the WTRU is measuring SSBs from its serving cell and/or camped-on cell, the WTRU may expect that no UL transmission may take place by the WTRUs in the cell. In another example, when the WTRU is measuring SSBs from a candidate cell, the WTRU may expect that no UL transmission may take place by the WTRUs in the corresponding candidate cell. That is, the WTRU may determine that in case CLI is measured and/or detected in the symbols that overlap with SSB transmission from the corresponding candidate cell, the CLI may be caused by the WTRUs in the serving cell or the WTRUs in another (e.g., neighbor) cells.

In example embodiments described herein, CLI is measured in the symbols overlapping with a first set of SSB transmissions from a candidate cell, where the CLI measurement enables the WTRU to determine the potential source of CLI. In case the WTRU determines that the source of CLI is from WTRUs in its serving cell, the WTRU may use a second set of SSBs for performing RRM measurements corresponding to the candidate cell. In an example, the second set of SSBs may be located in time in (e.g., SBFD) symbols, during which no UL transmission takes place in the serving cell, which may be referred to as clean SSBs. In the example embodiments described herein, the different types of SSB bursts are described, and conditions to select and measure SSBs based on the different types of SSB bursts are described. Example use cases for which the WTRU may measure the second SSB bursts are also described herein.

Example types of SSB bursts are described hereinafter, in accordance with the embodiments disclosed herein. In an example, a WTRU may be configured with and/or receive configuration information and/or indications on the transmission of one or more types of reference signals (RSs) and/or RS bursts in one or more cells, where the WTRU may determine the type of RSs to detect, receive, and/or measure based on one or more conditions. For example, wherein used in any of the examples disclosed herein, reference signals may comprise SSBs and/or SSB bursts, or any other RSs (e.g., CSI-RS, DM-RS, PT-RS, and/or SRS).

In an example, a WTRU may be configured with and/or receive configuration information and/or indications on the transmission of one or more types of SSB bursts in one or more cells, where the WTRU may determine the type of SSB bursts to detect, receive, and/or measure based on one or more conditions. For example, the WTRU may receive configuration on transmission of one or more types of SSB bursts in the serving cell and/or one or more neighbor, adjacent, and/or candidate cells. For example, the WTRU may determine, be configured, and/or indicated to receive, detect, and/or measure one or more SSBs from one or more types of SSB bursts from one or more cells. In an example, the WTRU may determine, be configured, and/or indicated to measure one or more quality parameters based on the received and/or detected SSBs. For example, the quality parameters may include, but are not limited to include, any of the following example quality parameters: RSRP, RSSI, CLI-RSSI, signal-to-noise ratio (SNR), SINR, and/or RSRQ.

In an example, the WTRU may be configured and/or receive configuration information on a first type of SSB burst and a second type of SSB burst. In an example, the SSB bursts with the second type may be a subset of the SSB bursts with the first type. For example, the SSB bursts with the first type may be configured with a first periodicity, and the SSB bursts with the second type may be configured with a second periodicity. In an example, the second periodicity may be based on the first periodicity. For example, the second periodicity may be a (pre) configured and/or indicated multiply of the first periodicity. In another example, the second periodicity may be separate from the first periodicity and with regards to a reference time, for example Frame 0. For example, the WTRU may be configured that, for example from Frame 0, starting from the kth SSB burst of the first type (e.g., k>=0), there may be one or more (e.g., n) SSB burst(s) of second type with a second periodicity. In another example, the WTRU may be configured that starting from kth SSB burst of the first type, there may be n (e.g., n>=1) SSB bursts of second type every m (e.g., m>=1) SSB bursts of the first type.

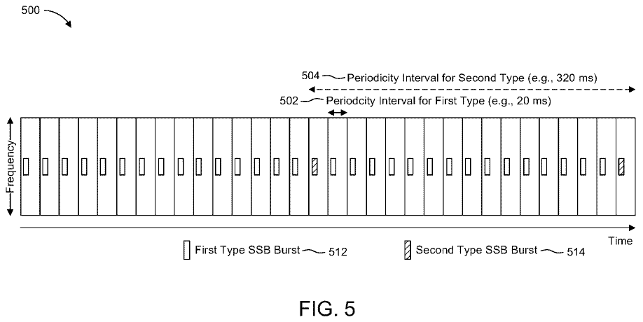

FIG. 5 is a scheduling diagram illustrating an example configuration 500 in time and frequency resources of first type SSB bursts 512 and second type SSB bursts 514 having different periodicity. In the example configuration 500, the periodicity 502 of first type SSB bursts 512 (e.g., 20 msec) is much shorter (i.e., more frequent) than the periodicity 504 of second type SSB bursts 514 (e.g., every 320 msec). In the example configuration 500, the 16th period of the first type SSB burst 512 is instead a second type SSB burst 514. In the example configuration 500, the frequency resources of the second type SSB burst 514 overlaps with the frequency resources of the first type of SSB burst 512.

In another example, SSB bursts of the second type may be configured separately from the SSB bursts of the first type, where the time and/or frequency resources during which the SSB burst of second type may be transmitted may be overlapping, partially overlapping, and/or non-overlapping with the time and frequency resources during which the SSB bursts of the first type may be transmitted. In an example, a WTRU may determine, be configured, and/or indicated that all SSB bursts in a cell may be of the first type. In another example, a WTRU may determine, be configured, and/or indicated that all SSB bursts in a cell may be of the second type.

In an example, the WTRU may receive the configuration information regarding the SSB bursts with the first type and the second type via one or more of the following: MIB; SIB; paging; RRC, MAC-CE, and/or DCI. Regarding MIB, in an example, after receiving and decoding an SSB from an SSB burst, for example from the serving cell and/or one or more neighbor cells, the WTRU may decode the PBCH and MIB from the received SSB. The WTRU may receive a flag indication, for example as part of PBCH or MIB, indicating whether the detected SSB burst is of a first type or a second type. Regarding SIB, in an example, after receiving and decoding the PBCH and MIB from the received SSB, the WTRU may receive configuration information on decoding and receiving one or more system information blocks (SIB). The WTRU may receive one or more SIBs (e.g., SIB1, SIB2, SIB3, etc.), where the SIBs may include one or more configuration information on one or more SSB bursts in the corresponding (e.g., serving) cell and/or one or more neighboring and/or candidate cells. Regarding paging, in an example, the WTRU (e.g., in RRC-Idle and/or RRC-Inactive modes) may be monitoring one or more paging occasions, during which the WTRU may receive one or more paging indications. The received paging indications may include one or more configuration information on one or more SSB bursts in the corresponding (e.g., serving) cell and/or one or more neighboring and/or candidate cells. Regarding RRC, MAC-CE, and/or DCI signaling, in an example, the WTRU (e.g., in RRC-Connected mode) may receive configuration one or more configuration information on one or more SSB bursts, RSs, RS bursts, etc. transmitted in the corresponding (e.g., serving) cell and/or one or more neighboring and/or candidate cells.

The received configuration information on each SSB burst may include one or more of the following example information: cell-ID; type of SSB burst indication; time resources information; frequency resources information; periodicity information; indication of a number of SSBs, SSB indexes, and/or SSB beams included in the SSB burst; thresholds and/or offset values; and/or report configurations. Regarding Cell-ID (cell identification), for example, the WTRU may receive the configuration information on one or more serving cell and/or neighbor cells, where the WTRU may receive the Cell-ID (e.g., physical-layer cell identity (PCID)) corresponding to the indicated cell. Regarding a type of the SSB burst, for example, the WTRU may receive one or more indications on whether an SSB burst may be of a first type, and/or a second type.

Regarding time resources information, for example, the WTRU may receive information indicating time resources during which one or more SSB bursts may be transmitted. The time resource configuration information may include, for example, the beginning (start time), duration, and/or end time for the corresponding SSB bursts. The beginning time may be based on a reference time (e.g., Frame 0). The time resources may be indicated based on number of time instances (e.g., number of symbols, slots, and/or subframes) or time units (e.g., seconds, milliseconds (msec), microseconds (microsec), etc.). In an example, the time resources may be indicated based on one or more determined, configured, and/or indicated time offset values, and based on one or more time references. For example, the time resources may be indicated based on one or more of: time patterns, the order of SSBs (e.g., SSB indexes) in the SSB burst, and/or number of symbols between successive SSBs.

Regarding frequency resources information, for example, the WTRU may receive information indicating frequency resources during which one or more SSB bursts may be transmitted. The frequency resource configuration information may include, for example, the beginning RB (start RB), number of RBs, and/or end RB (last RB) for the corresponding SSB bursts. The beginning RB may be based on a frequency offset according to a reference frequency (e.g., lowest PRB). Regarding periodicity information, for example, the WTRU may receive information indicating the time periodicity based on which one or more SSB bursts may be transmitted. Regarding a number of SSBs, SSB indexes, and/or SSB beams included in the SSB burst, for example, the WTRU may receive configuration information indicating the number of SSBs included in the SSB burst. In another example, the WTRU may receive the SSB indexes and/or indication of the SSB beams (e.g., TCI-states) included in the SSB burst.

Regarding thresholds and/or offset values, for example, the WTRU may receive configuration information including one or more of: offset values, threshold values, and/or scaling factors. In an example, the configuration information may be regarding evaluating the cell ranking value for the serving cell and one or more neighbor cells. In another example, the configuration information may be regarding evaluating one or more events, conditions, and/or triggers, for example for performing handover (HO), conditional handover (CHO), LTM and/or conditional-LTM cell switching. In an example, the threshold values, offset values, and/or scaling factors may correspond to the WTRU's speed, mobility status, inter-frequency cell selection, and/or intra-frequency cell selection.

Regarding report configuration information, for example, the WTRU may receive configuration information on one or more report configurations. In an example, the WTRU may receive one or more CSI report configurations, including the quality parameters to be measured based on the SSB bursts, in addition to the scheduled and/or configured UL grant for reporting the measurements. The report configurations may include the periodicity for measurement and reporting the indicated quality parameters.

Procedures and techniques for clean SSB bursts during UL muting occasions are disclosed herein. In example embodiments described herein, an example of a second type SSB burst is provided, where the second type SSB burst is a clean SSB burst. That is, the second type SSB burst in a second cell is a clean SSB burst with regards to (e.g., to cope with, to be used when determining) potential CLI due to UL transmissions in a first cell. In an example, this solution may be applicable in systems with synchronized cells, where the cells coordinate the time instances (e.g., via backhaul).

In an example, a WTRU may determine, be configured, and/or indicated with one or more second type SSB bursts associated with at least a determined, configured, and/or indicated second cell, wherein the WTRU may expect no UL transmission coinciding with the corresponding SSB symbols from the WTRUs in a first cell. For example, the first cell may be WTRU's serving cell and the second cell may be a neighbor cell. In another example, the first cell may be a neighbor cell, and the second cell may be WTRU's serving cell. In another example, the first cell may be a first neighbor cell, and the second cell may be a second neighbor cell. In another example, the WTRU may be configured with a set of first cells including one or more first cells. In another example, the WTRU may be configured with a set of second cells including one or more second cells. For example, the WTRU may receive configuration information on the first and second cells, for example including the first and second cells' Cell IDs (e.g., PCID). That is, the configuration information on the second type SSB burst may include the indications indicating the first and the second cell(s).

In an example, a WTRU that is camped on a first cell (e.g., gNB1) may receive configuration information on one or more first type SSB bursts, and/or second type SSB bursts, on one or more neighbor cells (e.g., gNB2). The WTRU may receive the configuration information on the second type SSB bursts from one or more second cells, with regards to and/or associated with the first cell. That is, the WTRU may receive the time and frequency resources, periodicity, etc. where the second type SSB bursts transmitted in the second cell(s) may be expected to be clean with regards to the first cell. In an example, the WTRU may receive the configuration information (e.g., via MIB, SIB, paging indication, RRC, MAC-CE, DCI, etc.) received from the first cell. In another example, the WTRU may receive the configuration information via MIB, SIB, paging, etc. received from the second cell.

In an example, the WTRU may measure one or more quality (e.g., channel quality, signal quality) parameters (e.g., RSRP) based on an SSB burst from a second cell (e.g., gNB2) (see for example FIG. 3). In case the measured SSB burst is a first type SSB burst, the WTRU may expect that there may be WTRUs in the first cell that may be scheduled and/or configured with UL transmission grants that may coincide with SSB symbols from the second cell. As such, the WTRU may expect the measured quality parameters (e.g., RSRP) based on the first type SSB burst received from the second cell may be impacted by potential CLI from the WTRUs in the first cell.

In case the measured SSB burst is a determined, indicated, and/or configured second type SSB burst from the second cell, the WTRU may expect that there will be no UL transmissions (e.g., no special type of interferences, a protected operation such as with “protected SSB”) in the first cell coinciding with the SSB symbols and/or slots of the second type SSB burst from the second cell. As such, the WTRU may expect the measured quality parameters (e.g., RSRP) based on the second type SSB burst received from the second cell to be clean (e.g., “protected”, “specially tagged”) from (e.g., not impacted by) any potential CLI (e.g., a certain pre-defined or pre-configured level of potential CLI) from the WTRUs in the first cell.

In an example, the WTRU may expect no UL transmission (e.g., no special type of interferences, no higher interference level than a threshold) from the WTRUs in the first cell coinciding in time with the SSB symbols and/or slots of the second type SSB burst from the second cell. In another example, the WTRU may expect no UL transmission (e.g., no special type of interferences, no higher interference level than a threshold) from the WTRUs in the first cell overlapping in frequency with the SSB frequencies of the second type SSB burst from the second cell. In another example, the WTRU may expect no UL transmission (e.g., no special type of interferences, no higher interference level than a threshold) from the WTRUs in the first cell overlapping in frequency with the edge RBs corresponding to the SSB frequencies of the second type SSB burst from the second cell.

In an example, the WTRU may determine the time and frequency of one or more clean (e.g., second type) SSB bursts (e.g., implicitly) based on one or more configuration information, indications, events, and/or conditions. For example, the WTRU may receive, be configured, and/or indicated with one or more UL muting and/or UL cancellation indications in a first cell. In an example, the WTRU that may be camped on a first cell may receive one or more UL muting, indicating that no WTRUs may be transmitting UL for a configured and/or indicated time duration over a configured and/or indicated RB length. In an example, the UL muting indication may correspond to the WTRU's serving cell and/or one or more candidate neighbor cells. The UL muting indication may include the Cell ID corresponding to the cells for which the UL muting configurations may be indicated. For example, the indication may indicate the Cell IDs (e.g., PCID) for which the UL muting may be indicated. For example, the indication may indicate that starting in I-ms, the UL muting takes place for t-ms, in the cell with PCID=C.

Procedures and techniques for clean SSB bursts during beam nulling occasions are disclosed herein. An example of a second type SSB burst is provided, where the second type SSB burst is a clean SSB burst. That is, the second type SSB burst in a second cell is associated with a beam nulling occasion in a first cell. In an example, this solution may be applicable in systems with synchronized cells, where the cells coordinate the time instances (e.g., via backhaul). For example, the first cell may be different from the second cell. In another example, the first cell may be the same as the second cell. That is, in an example, the WTRU may determine, be configured, and/or indicated with beam nulling configurations for its serving cell, where the beam nulling configurations may be provided based on (e.g., in a form of, via) RS ID(s), e.g., CSI-RS resource(s), SSB index(es), and/or TCI-state ID(s), and so on. In another example, the WTRU may determine, be configured, and/or indicated with beam nulling configurations for one or more neighbor, non-serving, and/or candidate cells, where the beam nulling configurations for one or more cells may be provided based on (e.g., in a form of, via) for example: RS ID(s), e.g., CSI-RS resource(s), SSB index(es), and/or TCI-state ID(s), which may be associated with a cell identifier (cell-ID), physical cell-ID (PCID), and/or a carrier index.

In an example, a WTRU that is camped on a first cell may receive configuration information on one or more first type SSB bursts, and/or second type SSB bursts on one or more neighbor cells. The WTRU may receive the configuration information on the second type SSB bursts from one or more second cells, with regards to and/or associated with the first cell. That is, the WTRU may receive the time and frequency resources, periodicity, etc. where the second type SSB bursts transmitted in the second cell(s) may be expected to be clean with regards to the first cell. In an example, the WTRU may receive the configuration information (e.g., via MIB, SIB, paging indication, RRC, MAC-CE, DCI) from the first cell. In another example, the WTRU may receive the configuration information (e.g., via MIB, SIB, paging indication, RRC, MAC-CE, DCI) from the second cell.

In an example, the WTRU may measure one or more quality parameters (e.g., RSRP) based on an SSB burst from a second cell (e.g., gNB2). In case the measured SSB burst is a first type SSB burst, the WTRU may expect that there may be WTRUs in the first cell that may be scheduled and/or configured with UL transmission grants based on one or more TCI-states (e.g., beam directions) that may coincide with SSB beams from the second cell. As such, the WTRU may expect the measured quality parameters (e.g., RSRP) based on the first type SSB burst received from the second cell may be impacted by potential CLI from the WTRUs in the first cell.

In case the measured SSB burst is a determined, indicated, and/or configured second type SSB burst from the second cell, the WTRU may expect that there will be beam nulling configured for one or more TCI-states in the symbols coinciding in time with the SSB symbols and/or slots of the second type SSB burst from the second cell. That is, the WTRU may expect that there would be no UL transmissions (e.g., no special type of interferences, a protected operation, e.g., with “protected SSB”, etc.) in the corresponding nulled beam directions in the first cell coinciding with the SSB symbols and/or slots of the second type SSB burst from the second cell. As such, the WTRU may expect the measured quality parameters (e.g., RSRP) based on the second type SSB burst received from the second cell to be clean (e.g., “protected”, “specially tagged”, etc.) from (e.g., not impacted by) any potential CLI (e.g., a certain pre-defined or pre-configured level of potential CLI) from the WTRUs in the first cell.

In an example, the WTRU may expect no UL transmission (e.g., no special type of interferences, no higher interference level than a threshold) from the WTRUs in the first cell in the nulled beam directions coinciding in time with the SSB symbols, slots, etc. of the second type SSB burst from the second cell. In another example, the WTRU may expect no UL transmission (e.g., no special type of interferences, no higher interference level than a threshold) from the WTRUs in the first cell in the nulled beam directions overlapping in frequency with the SSB frequencies of the second type SSB burst from the second cell. In another example, the WTRU may expect no UL transmission (e.g., no special type of interferences, no higher interference level than a threshold) from the WTRUs in the first cell in the nulled beam directions overlapping in frequency with the edge RBs corresponding to the SSB frequencies of the second type SSB burst from the second cell.

In an example, the WTRU may determine the time and frequency of one or more clean (e.g., second type) SSB bursts (e.g., implicitly) based on one or more configuration information, indications, events, and/or conditions. For example, the WTRU may receive, be configured, and/or indicated with one or more beam nulling indications in a first cell. In an example, the WTRU that may be camped on a first cell may receive one or more beam nulling indications, indicating that no UL or DL may be configured and/or scheduled in the nulled beam directions for a configured and/or indicated time duration over a configured and/or indicated RB length.

In an example, the beam nulling indication may correspond to the WTRU's serving cell and/or one or more candidate neighbor cells. The beam nulling indication may include the Cell ID corresponding to the cells for which the beam nulling configurations may be indicated. For example, the indication may indicate the Cell IDs (e.g., PCID) for which the beam nulling may be indicated. For example, the indication may indicate that starting in I-ms, the beam nulling takes place for t-ms, in the cell with PCID=C.

In another example, the beam nulling indication may include indications on one or more TCI-states and/or beam directions, for which the beam nulling may be indicated. As such, any communications, transmissions, and/or receptions on the indicated beam directions and/or TCI-states may be skipped and/or dropped during the indicated time and frequency resources.

Herein, the terms clean SSB burst, reduced CLI SSB burst, reduced interference SSB burst, UL muted SSB bursts, UL cancellation SSB bursts, beam nulling SSB bursts, and protected SSB burst may be used interchangeably.

Example conditions and use cases of clean SSB bursts are disclosed herein. Example conditions to use the second type SSB bursts (e.g., clean SSB bursts) are described. The provided conditions and/or events may be detected and/or triggered when the WTRU is using the first type SSB burst for measuring channel quality parameters. Upon triggering the events, the WTRU may switch to and/or select to use the second type SSB bursts for measuring channel quality parameters. In an example, the WTRU may receive one or more configuration information including threshold values, to evaluate the conditions and/or events. For example, the WTRU may receive the configuration information (e.g., via RRC, MAC-CE, DCI). One or more of the following conditions may apply:

In an example, there may be inconsistency in measured channel quality parameters. In an example, a WTRU may determine that different measurements on one or more quality parameter based on one or more SSBs in different SSB burst occasions may result in different measured values. In an example, the WTRU may determine that the difference between the measured values based on an SSB in different SSB bursts exceeds a determined, configured, and/or indicated threshold value. In an example, the WTRU may determine that the difference between the measured values based on an SSB in different SSB bursts is not within a determined, configured, and/or indicated range. In an example, the WTRU may determine that the measured RSRP based on an SSB received in one or more first SSB bursts may not be within the range of measured RSRP based on the same SSB in one or more second SSB bursts. The range may be a proportion, percentage, ratio of the measured values (e.g., 5%).

A WTRU may determine that the measured quality parameters in different SSB bursts may not be consistent, that is the measured values are not within the range of each other. In an example, in case the WTRU determines that there is an inconsistency in measured quality parameters, the WTRU may trigger one or more events. The triggered events may result in WTRU determining and selecting a mode of operation. The determined mode of operation may result in WTRU using the second type SSB bursts (e.g., clean SSB bursts) for performing channel measurements. In another example, the WTRU may trigger one or more events, resulting in measuring one or more channel quality parameters and/or interference values. For example, the WTRU may trigger an event resulting in measuring CLI based on one or more conditions. In an example, the WTRU may trigger to measure the CLI to determine if the reason for the inconsistent measurement is due to the CLI.

In an example, for a WTRU measuring RRM measurements based of its serving cell, in case the WTRU is closer to the center of the cell, the WTRU may not trigger CLI measurement. That is, for example, the WTRU for which the measured RRM measurements (e.g., RSRP) is higher than a corresponding threshold value may not trigger CLI measurement. In other words, for example, the WTRU that is closer to the center of the cell considers all SSBs and/or RSs received from the serving cell to be clean, regardless of the respective SSB bursts' type.

In another example, for a WTRU measuring RRM measurements based of its serving cell that is close to the cell edge, the WTRU may trigger CLI measurements. That is, for example, the WTRU for which the measured RRM measurements (e.g., RSRP) is lower than a corresponding threshold value may trigger CLI measurement. In other words, for example, the WTRU that is closer to the cell edge, measuring a first type SSB burst may trigger events leading to CLI measurement and/or switching to using and measuring to the second type SSB bursts for RRM measurements.

Procedures for measured CLI are disclosed herein. A WTRU may measure the CLI associated with one or more SSBs in one or more SSB bursts. In case the measured CLI is higher than a threshold, the WTRU may determine to trigger one or more events. The triggered events may result in WTRU determining the mode of operation with regard to measuring SSB bursts. The determined mode of operation may result in WTRU using the second type SSB bursts (e.g., clean SSB bursts).

Example procedures and configurations for CLI measurement and evaluation are described herein. Example configurations for measurements and evaluating CLI may be used, as described herein. A WTRU may receive one or more configuration information and/or indications on performing measurements and/or evaluating CLI along with performing one or more channel measurements in one or more candidate cells. For example, the WTRU may receive the configuration information (e.g., via SIB, paging indication, RRC, MAC-CE, DCI, etc.) In an example, the WTRU may receive the configuration information for measuring the CLI and using the measured CLI for evaluating LTM events for the configured candidate cells. In another example, the WTRU may receive the configuration information for measuring the CLI and using the measured CLI for evaluating cell ranking values for the configured candidate cells. In an example, the WTRU may receive the CLI measurement and reporting configurations as part of candidate cell configuration (e.g., via RRC). In another example, the WTRU may receive the CLI measurement and reporting configurations separate from the received configurations on the candidate cells configuration (e.g., via RRC, MAC-CE, DCI, etc.).

In an example, the WTRU may receive, be configured, and/or indicated with one or more sets of time and frequency resources for measuring CLI (e.g., CLI-RSSI) (e.g., a new IE CLI-RSSI-MeasurementResourceSet) containing one or more sets of configuration information of CLI measurement resource(s) (e.g., CLI-RSSI-MeasurementResource), for example for L1 CLI-RSSI measurement. In an example, the CLI-RSSI measurement resource configurations may include CLI measurement resource ID, starting PRB index, number of PRBs, starting symbol of the CLI resource within a slot, number of symbols of the CLI resource within a slot, and/or periodicity and slot offset for the CLI resource. In an example, the WTRU may be configured with one or more zero-power (ZP) CSI-interference measurement (CSI-IM), crosslink-IM (CL-IM), and/or CSI-RS resources for measuring the CLI. For example, the configured ZP CLI measurement resources may be fully overlapping, partially overlapping, and/or non-overlapping in time with one or more SSB symbols in one or more SSB bursts. In an example, the configured ZP CLI measurement resources may coincide in time with one or more SSB symbols from one or more SSB bursts. In another example, the configured ZP CLI measurement resources may be within a configured range in time with one or more SSB symbols from one or more SSB bursts.

Example procedures for determining time resources for CLI measurement are described herein. A WTRU may receive, be configured, and/or indicated to determine and/or select the time resources for measuring CLI with respect to and/or associated with the timing of the SSB symbols in the SSB burst. For example, the WTRU may be configured and/or indicated to determine the starting symbol and the time duration for CLI measurement resources based on the timing of the SSBs transmitted from a candidate cell. In an example, the WTRU may be configured and/or indicated to determine the starting symbol and/or time duration for CLI measurement resources based on the starting symbol and/or time duration of the SSBs, respectively, for example per SSB transmission occasion. In another example, the WTRU may be configured and/or indicated to determine the starting symbol and/or time duration for CLI measurement resources based on the starting symbol of the SSBs and/or time duration of SSB occasions, respectively, in addition to one or more configured and/or indicated offset values. For example, the configured and/or indicated offset values may be based on absolute time unit values (e.g., msec, microsec, etc.) and/or based on time instances (e.g., symbols, slots, etc.). In another example, the WTRU may be explicitly configured and/or indicated with the time resources, starting symbol, and/or time duration for CLI measurement.

Example procedures for determining frequency resources for CLI measurement are described herein. A WTRU may receive, be configured, and/or indicated to determine and/or select the frequency resources for measuring CLI with respect to and/or associated with the frequency resources of the SSB symbols in the SSB burst. For example, the WTRU may be configured and/or indicated to determine the starting RB and the RB length for CLI measurement resources based on the frequency of the SSBs transmitted from a candidate cell. In an example, the WTRU may be configured and/or indicated to determine the starting RB and/or RB length for CLI measurement resources based on the starting RB and/or RB length of the SSBs, for example per SSB transmission occasion, respectively. In another example, the WTRU may be configured and/or indicated to determine the starting RB and/or RB length for CLI measurement resources based on the starting RB and/or RB length of the SSBs in addition to one or more configured and/or indicated offset values. For example, the configured and/or indicated offset values may be based on number of RBs, PRBs, and/or subbands. In another example, the WTRU may be explicitly configured and/or indicated with the frequency resources, starting RB, and/or RB length for CLI measurement.

Regarding CLI threshold values, in an example, a WTRU may be configured and/or indicated with one or more threshold corresponding to CLI measurements. The threshold values may be associated with time duration, number of RBs, RB length, etc. used for CLI measurements.

Regarding second TCI-states or RSs (e.g., for CLI measurement), in an example, a WTRU may be configured and/or indicated with one or more second TCI-states (or one or more second RSs, e.g., in a configured RS set, for CLI measurements). For example, the WTRU may be configured and/or indicated directly with the one or more second RSs (e.g., SSBs, CSI-RSs, etc.), e.g., in a configured RS set, from (e.g., associated with) a candidate cell. For example, the WTRU may be configured and/or indicated with the second TCI states based on one or more reference signals (RSs) (e.g., SSBs, CSI-RSs, etc.) from a candidate cell. In an example, the WTRU may activate and/or use the configured second TCI states for measuring one or more quality parameters (e.g., RSRP, RSRQ, RSSI, SNR, etc.) based on one or more RSs (e.g., SSB, CSI-RS, etc.) received from the candidate cell. In another example, the WTRU may activate and/or use the configured second TCI states for measuring one or more CLI parameters (e.g., CLI-RSSI, SRS-RSRP, etc.) based on one or more RSs (e.g., SSB, CSI-RS, etc.) received from the candidate cell. In an example, the second TCI-states may be different from or the same as the TCI-states configured as part of the candidate cell configurations.

Example procedures for CLI measurement are described herein. A WTRU may perform CLI measurement based on one or more CLI measurement resources, where the WTRU may determine the source of CLI based on the measured CLI value. For example, the WTRU may determine, be configured, and/or indicated to use a second TCI-state (or a second RS) to measure the CLI in the beam direction towards a candidate (e.g., non-serving) cell. In another example, the WTRU may determine, be configured, and/or indicated to measure the CLI in the same symbols as the SSB transmission in a candidate (e.g., non-serving) cell. For example, the WTRU may measure one or more first CLI measurements in UL PRBs, SBs, BWPs, etc., for example in SBFD symbols. In another example, the WTRU may measure one or more second CLI measurements in DL PRBs, SBs, BWPs, etc., for example in SBFD symbols. In an example, the first and/or second CLI measurements may be based on CLI-RSSI or SRS-RSRP measurement.

In an example, for a WTRU that is measuring one or more quality parameters during a first type SSB burst transmission, the WTRU may measure CLI. One or more of the following examples may apply:—CLI from UEs in the serving cell; and/or CLI from WTRUs in other cells. Regarding CLI from WTRUs in the serving cell, since UL transmission is not allowed in the candidate beam during first type SSB bursts transmission, if the measured first CLI in UL frequency resources is higher than a threshold and higher than the second CLI measured in DL frequency resources, this may indicate that the first CLI may be caused by one or more WTRUs in the serving cell. Regarding CLI from WTRUs in other cells, if the measured first CLI in UL frequency resources is within a configured range from the second CLI measured in DL frequency resources, this may indicate that the first and second CLI may be caused by one or more WTRUs in the cells other than the serving and the candidate cell.

A WTRU that has measured and/or detected strong CLI from one or more WTRUs in the serving cell may determine to use, receive, detect, and/or measure one or more second type SSB burst (e.g., clean SSB bursts). For example, the WTRU may determine the CLI to be strong if the measured CLI is more than a configured threshold. In an example, the WTRU may determine that the measured strong CLI may affect one or more channel measurements from a candidate cell. For example, the WTRU may determine that the CLI may affect the signal strength measurement based on the first type SSB bursts from a candidate cell, thus affecting the LTM events evaluations. In another example, the WTRU may determine that the CLI may affect the signal strength measurement (e.g., RSRP, RSRQ, RSSI, and/or SNR) based on the first type SSB bursts from a candidate cell, thus affecting the cell ranking evaluations and cell (re) selection procedures. For example, the WTRU may determine to use the first type SSB burst for measuring the channel quality parameters and/or evaluation of one or more events if the measured CLI is lower than the threshold. In another example, the WTRU may determine to use the second type SSB burst for measuring the channel quality parameters and/or evaluation of one or more events if the measured CLI is higher than the threshold.

In an example, CLI measurement association may be used with SSBs. In an example, the WTRU may measure CLI in CLI measurement resources that may be associated with one or more received and/or measured SSBs. That is, for the SSBs and/or SSB beams that the WTRU measures RSRP, the WTRU may be configured with a time duration or frequency length for measuring the CLI. For example, the configured time and frequency resources may overlap with the time and frequency resources corresponding to the transmitted SSBs. In an example, the WTRU may measure the CLI in the indicated resources that may start one or more symbols before an SSB transmission occasion until one or more symbols after the SSB transmission occasion.

For example, the WTRU may be configured with the associated SSB indexes as part of the CLI measurement resources and/or reporting configurations. In another example, the WTRU may determine the association between SSB indexes and CLI measurement resources based on the overlapping of the CLI measurement resources with the transmitted SSB occasions. That is, for example, if the resources configured for CLI measurement fully overlaps or partially overlaps or is within a configured range from an SSB transmission occasion, the WTRU may consider the CLI measurement resources to be associated with the corresponding SSB index. For example, the configured range in time may be based on the time distance between CLI measurement time resources and the SSB transmission time occasion. For example, the time range may be configured based on absolute time units (e.g., msec, microsec, etc.), or based on the number of time instances (e.g., symbols, slots, etc.). In another example, the configured range in frequency may be based on the frequency distance between CLI measurement frequency resources and the SSB transmission frequencies. For example, the frequency range may be configured based on absolute frequency units (e.g., kHz, MHz, etc.), or based on the number of RBs, PRBs, etc.

In an example, the WTRU may be configured to measure the CLI based on aperiodic resources and/or measurements (e.g., based on configured slot offset and/or starting time). In another example, the WTRU may be configured to measure the CLI based on semi-persistent resources and/or measurements (e.g., based on configured starting symbol, time duration, end time, etc.) (e.g., based on SSB transmission occasions in the configured time window). In another example, the WTRU may be configured to measure the CLI based on periodic resources and/or measurements (e.g., based on configured starting symbol, time periodicity, etc.).

In an example, a WTRU may consider an SSB occasion as affected by the CLI if the measured CLI in the resources associated with the SSB occasion is higher than a determined, configured, and/or indicated CLI threshold. For example, the WTRU may receive, be configured, and/or indicated with one or more CLI threshold values. As such, the WTRU may compare the measured CLI associated with an SSB occasion with one or more of the configured threshold values. If the measured CLI is higher than a configured threshold, the WTRU may consider the associated SSB occasion to be affected by the CLI. In an example, the WTRU may determine, be configured, and/or indicated to measure the CLI associated with an SSB occasion based on CLI-RSSI, SRS-RSRP, etc. In another example, the WTRU may determine, be configured, and/or indicated to measure the CLI associated with an SSB occasion that may be in SBFD symbols based on UL subbands and/or DL subbands in the configured SBFD symbols.

Procedures and techniques for clean SSB bursts in RRM measurements are disclosed herein. An example use case of clean SSB bursts in RRM measurements is described. In an example, a WTRU may trigger an event to determine the mode of operation with regards to selecting, using, and/or measuring the SSB bursts from one or more cells for RRM measurements based on one or more conditions. In an example, the WTRU may measure RRM measurements based on its serving cell and/or one or more candidate neighbor non-serving cells. In an example, the WTRU may receive one or more configuration information regarding the RRM measurements, where the WTRU may receive the configuration information, for example from a gNB (e.g., via RRC, MAC-CE, DCI, etc.). Based on the conditions and corresponding triggered events, the WTRU may select to use one or more CSI resources and/or reference signals.

Regarding SSB burst types, in an example, the WTRU may determine, be configured, and/or indicated with a first type SSB burst and a second type SSB burst. For example, the second type SSB burst may be a clean SSB burst with regards to one or more cells. The WTRU may determine, be configured, and/or indicated to measure the RRM measurements based on the second SSB burst based on one or more conditions.

Regarding ZP CSI resources, in an example, the WTRU may determine, be configured, and/or indicated with one or more CSI report configurations, where the measurements and/or reporting may be based on one or more first type or second type CSI resources. For example, the configured and/or indicated CSI report configurations may include one or more CLI measurements. In an example, the first type CSI resources may be based on zero-power (ZP) CSI resources (e.g., ZP-CSI-RS resources, ZP-RS resources). For example, the WTRU may measure the RRM measurements and/or the received CLI signal strength based on the first type CSI resources. The WTRU may expect the first type ZP CSI resources to be affected by potential CLI from the WTRUs transmitting uplink in resources that coincides in time with the configured first type ZP CSI resources.

In another example, the second type CSI resources may be based on ZP-UL CSI resources. For example, the WTRU may expect that no UL transmission may be performed in the ZP-UL CSI resources. In an example, the ZP-UL CSI resources may be clean and/or protected CSI resources. In an example, the WTRU may measure RRM measurements based on the first type SSB bursts based on the ZP-UL CSI resources. In an example, the ZP-UL CSI resources may be a subset of first type ZP CSI resources. For example, the WTRU may be configured with the first type ZP CSI resources with a first periodicity. The WTRU may be configured to determine the ZP-UL CSI resources based on the first type CSI resources with a second periodicity. That is, the WTRU may be configured with n second type ZP-UL CSI resources per every m^{th} first type ZP CSI resources. In another example, the ZP-UL CSI resources may be configured separately from the first type ZP CSI resources, where the WTRU may receive one or more configuration information regarding the ZP-UL CSI resources. The configuration information may include information such as the time and frequency resources, the periodicity, etc.

Regarding modes of operation, in an example, a condition to use the second type SSB bursts and/or second type ZP-UL CSI resources may be inconsistent RRM measurements. For example, the WTRU may determine a condition where the RRM measurements based on one or more first SSB bursts may be inconsistent and/or out of range with regards to RRM measurements based on one or more second SSB bursts. In another example, the WTRU may determine a condition where the measured CLI based on one or more SSB bursts may be higher than a configured and/or indicated threshold value. As such, the WTRU may trigger one or more events. Based on the triggered events, the WTRU may determine the mode of operation in measuring RRM measurements. One or more of the following modes of operation may apply: first mode of operation; second mode of operation; and/or third mode of operation.

For example, a first mode of operation may use the second type SSB bursts or the second type ZP CSI resources. For example, a WTRU may determine, be configured, and/or indicated to operate based on the first mode of operation if the number of measured strong CLI (e.g., CLI higher than a threshold) based on SSBs, e.g., in different SSB bursts, for example in a configured time window, may be higher than a configured MAX number. In an example, the WTRU may receive one or more configuration information including a time window, where the time window may be the same as the time window configured for measuring, filtering, and/or evaluating the measured RSRPs. In another example, the received configuration information may include the MAX number of measured strong CLI based on SSBs in different SSB bursts in the configured time window. The WTRU may initiate a counter to a first value (e.g., zero). The WTRU may measure one or more quality parameters based on SSBs in a first type SSB burst. The WTRU may measure the CLI (e.g., L1-CLI-RSSI) in CLI measurement resources associated with one or more SSBs within the configured time window. In case any of the measured CLI is higher than a threshold value, the WTRU may increment the counter by a second value (e.g., one). At the end of the time window, in case the evaluated counter is higher than the MAX number, the WTRU may trigger an event to switch the mode of operation and to operate based on the first mode of operation.

In another example, a WTRU may determine, be configured, and/or indicated to operate based on the first mode of operation if the number of inconsistent RRM measurements, for example in a configured time window, may be higher than a configured RRM-MAX number. In an example, the WTRU may receive one or more configuration information including a time window, where the time window may be the same as the time window configured for measuring, filtering, and/or evaluating the measured quality parameters. In another example, the received configuration information may include the RRM-MAX number of RRM measurements that may be inconsistent in the configured time window. The WTRU may initiate a counter to a first value (e.g., zero). The WTRU may measure one or more quality parameters based on SSBs in a first type SSB burst. The WTRU may measure RRM measurements based on one or more SSBs within the configured time window. In case any of the RRM measurements is inconsistent and/or out of range with regards to RRM measurements based on SSBs in other SSB bursts, the WTRU may increment the counter by a second value (e.g., one). At the end of the time window, in case the evaluated counter is higher than the RRM-MAX number, the WTRU may trigger an event to switch the mode of operation and to operate based on the first mode of operation.

In an example, in the first mode of operation, the WTRU may determine, be configured, and/or indicated to use, detect, and/or measure the second type SSB bursts (e.g., clean SSB bursts) for RRM measurements. In another example, in the first mode of operation, the WTRU may determine, be configured, and/or indicated to use the second ZP-UL CSI resources to detect and/or measure the first type SSB bursts for RRM measurements.

For example, a second mode of operation may skip the measurements affected by CLI. In an example, in case the number of SSB occasions that are determined to be affected by the CLI, for example in a configured time window, is lower than the configured MAX number, the WTRU may determine to trigger an event to switch the mode of operation and to use the second mode of operation. As such, the WTRU may skip and/or discard the RRM measurements based on the SSB occasions that are affected by the CLI in evaluating, calculating, and/or averaging the RRM measurements in the configured time window. In another example, the WTRU may apply at least one bias parameter (e.g., a function, a penalty parameter, a prioritization parameter, a weighting factor or coefficient affecting evaluation of the SSB measurement) based on (e.g., on top of, in combination with) the RRM measurements based on the SSB occasions that are affected by the CLI, e.g., in determining, evaluating, calculating, and/or averaging the RSRP measurements in the configured time window.

In another example, in case the number of inconsistent RRM measurements (e.g., out of range RRM measurements), for example in a configured time window, is lower than the configured RRM-MAX number, the WTRU may determine to trigger an event to use the second mode of operation. As such, the WTRU may skip and/or discard the out of range RRM measurements in evaluating, calculating, and/or averaging the RRM measurements in the configured time window.

For example, a third mode of operation may use the first type SSB busts. In an example, the WTRU may receive one or more configuration information including a time window, and a MIN number of measured strong CLI (e.g., CLI higher than a threshold) based on SSBs, e.g., in different SSB bursts, in a configured time window. In an example, in case the number of SSB occasions that are determined to be affected by the CLI, for example in a configured time window, is lower than the configured MIN number, the WTRU may trigger an event to switch the mode of operation and to use the third mode of operation. In an example, the WTRU may receive one or more configuration information including a time window, and an RRM-MIN number of measured out of range RRM measurements, in a configured time window. In an example, in case the number of out-of-range RRM measurements, for example in a configured time window, is lower than the configured RRM-MIN number, the WTRU may trigger an event to use the third mode of operation. For example, if the previous mode of operation is based on the third mode of operation, the WTRU may not trigger any events and the WTRU may continue operating based on the third mode of operation. That is, the WTRU may continue using the first type SSB bursts. As such, the WTRU may use the first type SSB bursts for measuring the quality parameters.

Example reporting procedures are described herein. A WTRU may determine, be configured, and/or indicated to trigger an event to send a report (e.g., to a gNB). The WTRU may trigger the event due to one or more conditions, where the conditions may include: out-of-range (e.g., inconsistent) RRM measurements, and/or strong measured CLI. The WTRU may report the out-of-range RRM measurement values. The WTRU may report the measured CLI. In an example, the WTRU may be configured with one or more report configuration (e.g., CSI report configuration). The report configurations may include the time and frequency grants for sending the report, the type of the report including periodic, semi-persistent, and/or indication of aperiodic, etc. In an example, the WTRU may determine, be configured, and/or indicated to report the measured CLI if the WTRU determines that the source of CLI is from a candidate cell. In another example, the WTRU may determine, be configured, and/or indicated to report the measured CLI if the WTRU determines that the source of CLI is from the serving cell. In another example, the WTRU may determine, be configured, and/or indicated to report the measured CLI if the measured CLI is higher than a configured CLI-MAX threshold value.

In an example, the WTRU may send a report comprising reporting information, where the reporting information may include any one or more of the following example information: SSB burst type; measured values; TCI-state (or RS, directly) used for measurements; Associated SSB index; Candidate cell; Time instances where the events were detected and/or measured; frequency resources; Measurements in SBFD or non-SBFD symbols; and/or Whether CLI was measured in symbols overlapping with SSBs.

For SSB burst type, for example, the WTRU may indicate the type of the SSB burst, based on which the out-of-range RRM measurements and/or the CLI was measured. For example, the WTRU may send a flag indication, where a first value (e.g., zero) may indicate that the measurement and the event to report may be based on the first type SSB bursts; a second value (e.g., one) may indicate that the measurement and the event to report may be based on the second type SSB bursts (e.g., clean SSB bursts). For measured values, for example, the WTRU may report the out-of-range RRM measurements (e.g., RSRP, RSRQ, SNR, etc.) and/or the measured CLI (e.g. CLI-RSSI, SRS-RSRP, etc.). For TCI-state (or RS, directly) used for measurements, for example, the WTRU may report the TCI-state (or RS) that the WTRU used for measuring the reported values. In an example, the TCI-state (or RS) may be associated with a beam direction towards the candidate cell. For associated SSB index, for example, the WTRU may report the SSB index, for which the RRM measurements may be out-of-range. In another example, the WTRU may report the SSB index, for which the measurement on the quality parameters (e.g., RSRP, RSRQ, SNR, etc.) may be affected by the reported CLI. In an example, the reported SSB index may be from a candidate cell.

For candidate cell for example, the WTRU may report the candidate cell, e.g., corresponding cell ID and/or PCI, for which the quality parameters measurement may be affected by the reported CLI. For time instances where the events were detected and/or measured, for example, the WTRU may report the time instances (e.g., symbols, slots, etc.) including the starting symbol, the time duration, and/or the end symbol during which the reported out-of-range RRM measurements and/or CLI was measured. In another example, the WTRU may indicate the time instances during which the CLI was detected to be higher than one or more threshold values. In an example, the WTRU may indicate that the CLI measurement was only based on a subset of CLI measurement resources, where the measured CLI was higher than a threshold. In an example, the WTRU may indicate that the CLI measurement was based on all configured CLI measurement resources, regardless of whether the measured CLI was higher or lower than a threshold.

For frequency resources, for example, the WTRU may report the frequency resources (e.g., RBs) including the starting RB, the RB length, and/or the end RBs which the reported RRM measurements and/or CLI were measured. In another example, the WTRU may indicate if the CLI measurements was performed in the UL subband or the DL subband. In another example, the WTRU may indicate that the reported CLI was measured in RBs that were fully overlapping, partially overlapping, or non-overlapping with SSB RBs. For measurements in SBFD or non-SBFD symbols, for example, the WTRU may indicate whether the reported CLI was measured in SBFD or non-SBFD symbols. In another example, the WTRU may indicate whether the reported out-of-range RRM measurements were measured in SBFD or non-SBFD symbols. For whether CLI was measured in symbols overlapping with SSBs, for example, the WTRU may indicate that the reported CLI was measured in symbols that were fully overlapping, partially overlapping, or non-overlapping with SSB symbols. In an example, the WTRU may indicate the overlapping with SSB symbols based on SSBs from the candidate cell.

Procedures and techniques for clean SSB bursts in cell (re) selection operation are disclosed herein. An example use case of clean SSB bursts in cell (re) selection procedures is provided. In an example, candidate cells configuration information may be used for cell (re) selection. A WTRU may be in RRC-Idle or RRC-Inactive state, where the WTRU may calculate and/or evaluate cell ranking values for the serving cell and one or more neighbor target cells, for example as part of cell (re) selection procedure.

In an example, the WTRU may receive and/or detect one or more SSBs from its serving cell. For example, the serving cell may be the last cell that the WTRU was connected to. In another example, the WTRU may receive and/or detect one or more SSBs from a neighbor candidate cell. The WTRU may receive a physical broadcast channel (PBCH). The PBCH may carry system information. The PBCH may include or carry a master information block (MIB). The term MIB may be used to represent the content, information, payload, and/or bits carried by the PBCH. PBCH and MIB may be used interchangeably herein. The PBCH may be part of an SSB. The SSB may have an SSB index. The WTRU may use the configuration information (e.g., received via MIB) to decode, receive, and/or detect one or more SIBs. The WTRU may receive one or more configuration information regarding the serving cell and one or more candidate cells based on the decoded MIB and SIBs from serving cell and candidate cells, respectively. In an example, the SIBs received from the serving cell may include one or more configuration information on one or more candidate cells. One or more of the following example information regarding the FD operation in the serving cell and/or candidate cells may be included in the corresponding configuration information: SBFD mode information; SBFD time and frequency resources information; CLI measurement resources information; threshold values; offset values; compensation values; and/or scaling parameters.

Regarding SBFD mode information, for example, the WTRU may determine if the detected cell supports SBFD operation or that the detected cell operates in a non-SBFD mode of operation. Regarding SBFD time and frequency resources information, for example, the WTRU may receive configuration information on time and frequency resources were SBFD may be applied. For example, the WTRU may receive the starting symbol, time duration, starting PRB, RB length, guard bands, UL subbands, DL subbands, and/or direction of transmission. Regarding CLI measurement resources information, for example, the WTRU may receive configuration information on one or more CLI measurement resources, including the starting symbol, time duration, starting PRB, RB length, CLI measurement configuration ID, and/or reference signals for CLI measurement (e.g., SRS configuration for SRS-RSRP measurement).

Example procedures for evaluating cell ranking of a candidate cell are described herein. A WTRU may determine, select, and/or use a first set of TCI-states for measuring one or more channel and/or interference parameters from a serving cell. The WTRU may determine, select, and/or use a second set of TCI-states for measuring one or more channel and/or interference parameters from a neighbor, non-serving, and/or candidate cell.

In an example (e.g., as part of cell (re) selection procedure), a WTRU may use the determined second set of TCI-states for measuring one or more quality parameters (e.g., RSRP, RSRQ, SINR, etc.). In an example, the WTRU may measure the quality parameters based on one or more SSBs from the candidate cell. For example, the WTRU operating in SBFD resources may use the DL subband for receiving and measuring the SSBs from the candidate cell. In another example, the WTRU operating in SBFD resources may use the UL subband for receiving the SSBs and measuring the received signal strength from the candidate cell.

In an example, a WTRU may use one or more determined second TCI states for measuring CLI based on one or more CLI measurement resources from a candidate cell. In an example, the WTRU may determine, be (pre) configured, and/or (pre) indicated to measure CLI in the same symbols and/or at the same time as SSB transmission from the candidate cell. In an example, the WTRU may perform the CLI measurement from the candidate cell as part of cell (re) selection procedure. For example, the WTRU may measure CLI-RSSI, SRS-RSRP, etc. from the candidate cell. In an example, the WTRU operating in SBFD resources may use the CLI measurement resources in the UL subband for receiving and measuring the CLI from the candidate cell. In another example, the WTRU operating in SBFD resources may use the CLI measurement resources in the DL subband for receiving and measuring the CLI from the candidate cell. In an example, the WTRU may determine that the measured CLI may be caused by the WTRUs in the serving cell, as described herein.

In an example, in case a WTRU determines that measuring one or more quality parameters based on one or more SSBs from a first type SSB burst from a candidate cell may be impacted by CLI, the WTRU may determine the mode of operation based on one or more conditions. For example, the WTRU may be configured and/or indicated with one or more configuration information and/or indications on one or more modes of operation. The WTRU may be configured and/or indicated with one or more conditions, based on which the WTRU may choose the mode of operation. For example, the WTRU may receive the configuration information and/or indications (e.g., via MIB, SIB, paging indications, etc.), for example detected from the serving cell and/or the candidate cell.

A WTRU may measure CLI based on one or more SSBs received from one or more first type SSB bursts. The WTRU may determine, be configured, and/or indicated to operate based on a first mode of operation if the number of measured strong CLI (e.g., CLI higher than a threshold) based on SSBs in different SSB bursts, for example in a configured time window, is higher than a configured maximum (MAX) number. The WTRU may determine to operate based on a second mode of operation if the number of measured strong CLI based on SSBs in different SSB bursts in the configured time window, is lower than the MAX number. In another example, the WTRU may determine to operate based on a third mode of operation if the number of measured strong CLI based on SSBs in different SSB bursts in the configured time window, is lower than a configured minimum (MIN) number.

In an example, the WTRU may determine and/or be (pre) configured with a time window, where the time window may be the same as the time window used for measuring, filtering, and/or evaluating the measured RRM measurements (e.g., RSRP, RSRQ, etc.). In another example, the WTRU may determine, be (pre) configured, or receive configuration information on the MAX and MIN number of measured strong CLI based on SSBs in different SSB bursts in the configured time window.

In an example, one or more of the following example modes of operation may apply: first mode of operation; second mode of operation; and/or third mode of operation. For example, a first mode of operation may use second type SSB burst. For example, a WTRU may use the second type SSB bursts for receiving and/or measuring one or more quality parameters from a candidate cell. In an example, a second mode of operation may skip the measurements affected by CLI. For example, a WTRU may skip and/or discard the measurements on the quality parameters (e.g., RSRP, RSRQ, etc.) based on the SSB occasions that are affected by the CLI in evaluating, calculating, and/or averaging the quality parameters measurements in the configured time window. In another example, the WTRU may apply at least one bias parameter (e.g., a penalty parameter, a prioritization parameter, a weighting factor or coefficient affecting evaluation of the SSB measurement) based on (e.g., on top of, in combination with) the quality parameters measurements based on the SSB occasions that are affected by the CLI, e.g., in determining, evaluating, calculating, and/or averaging the quality parameters in the configured time window. In an example, a third mode of operation may use the first type SSB burst. For example, a WTRU may use the first type SSB bursts for receiving and/or measuring one or more quality parameters from a candidate cell. In an example, if the previous mode of operation is based on the third mode of operation, the WTRU may not trigger any events and the WTRU may continue operating based on the third mode of operation. That is, in case the SSB measurements based on first type SSB bursts is not affected by the CLI, the WTRU may continue using the first type SSB bursts. As such, the WTRU may use the first type SSB bursts for measuring the quality parameters.

Procedures for cell ranking are described herein. The WTRU may evaluate the cell ranking values based on the measured quality parameters for the serving cell and one or more neighbor, non-serving, and/or candidate cells. In an example, based on the evaluated cell ranking values, the WTRU may determine to select a candidate cell with the highest evaluated cell ranking. The WTRU may send PRACH to the selected candidate cell, e.g., to connect to the cell. In an example, the WTRU may use the measured quality parameters for calculating PRACH UL power, based on received SSBs from the second type SSB bursts, in case the cell ranking value is measured based on the received SSBs from the second type SSB bursts. In an example, a WTRU may calculate the PRACH UL power based on the measured RSRP based on the received SSB, as described herein. In an example, in case the WTRU used the RRM measurements based on the second type SSB burst for calculating the cell raking value, the WTRU may calculate the PRACH UL power based on the pathloss parameter calculated based on the quality parameters that may be measured based on the SSB in the second type SSB bursts.

After connecting to the candidate cell, the WTRU may send a report to indicate one or more information regarding the measured CLI. The report may include one or more example parameters, such as the type of the SSB burst used for measuring the quality parameters for evaluating the cell ranking values, measured CLI, the TCI-state used for measuring the CLI, the SSB index (e.g., associated SSB index), the candidate cell ID, the time instances where CLI was detected and/or measured, whether CLI was measured in SBFD or non-SBFD symbols, whether CLI was measured in symbols overlapping with SSBs, and/or whether CLI was measured in RBs overlapping with SSBs.

In another example, the WTRU may determine that the measured CLI based on the first type SSB bursts may be lower than a corresponding threshold. As such, the WTRU may measure the quality parameters based on the first type SSB burst and evaluate the cell ranking value for the serving cell and/or one or more neighbor cells, accordingly. In an example, the WTRU may determine that the evaluated cell ranking values for the neighbor cells is not higher than the one for the serving cell. As such, the WTRU may determine to stay camped-on the serving cell and not perform cell (re) selection.

Procedures and techniques for clean SSB bursts in cell switching operation(s) are described. An example use case of clean SSB bursts in cell switching operation is described. In an example, candidate cells configuration may be used for cell switching. A WTRU may be connected to a serving cell, where the WTRU may determine, be configured, and/or indicated to perform transmission and/or reception based on a first activated TCI-state from the serving cell. In an example, the WTRU may be in RRC-Connected state.

The WTRU may receive, identify, be configured, and/or indicated to report (L1) (RRM) measurement reports, for example based on a candidate and/or candidate cell. The WTRU may receive indications (e.g., via MAC-CE, DCI, etc.) (e.g., from the serving cell) to change, configure, and initiate switching WTRU's serving cell to the candidate cell, for example based on the reported measurements. In an example, the WTRU may receive one or more configuration information on one or more candidate cells. For example, the WTRU may receive the configuration information via RRC signaling. In an example, the WTRU may receive configuration information for LTM cell switching. For example, the WTRU may receive configuration information for a (pre) configured maximum number of (e.g., eight) candidate cells. In an example, the WTRU may receive configuration information for each configured candidate cell, for example including one or more of the following: candidate cell ID; candidate Cell PCI; candidate cell RRC configuration; configurations on special modes of operation; TCI states (or RSs, directly); CSI report configurations; NZP CSI-RS resource(s) and/or resource set(s); and/or SSB configuration (Config).

For candidate cell ID for example, the WTRU may receive configured candidate cell's index, identification, etc. For candidate cell PCI for example, the WTRU may receive configured candidate cell's Physical Cell ID (PCI). For candidate cell RRC configuration for example, the WTRU may receive one or more RRC configurations corresponding to the candidate cell (e.g., via Itm-CandidateConfig). For configurations on special modes of operation for example, the WTRU may receive configuration information on time and frequency resources where a special mode of operation is applied in the candidate cell. For example, the special mode of operation may be SBFD operation, cell DRX, and/or cell discontinuous transmission (DTX). For example, the WTRU may receive configuration information on time and frequency resources where the special mode of operation is applied. In an example, the WTRU may receive configurations on the starting time, number of symbols, slots, frames, etc. where the configurations regarding the special mode of operation may be applied. In another example, the WTRU may receive configurations on the starting RB, RB offsets, number of RBs, subbands, BWPs, direction of transmission in different RBs, guard bands, etc. where the configurations regarding the special mode of operation may be applied.

For TCI states (or RSs, directly) for example, the WTRU may receive one or more second TCI states (or RSs) for LTM cell switch to the corresponding candidate cell, where the configured TCI states may consist of UL, DL, and/or joint UL and DL TCI states. For CSI report configurations for example, the WTRU may receive one or more CSI report configurations including any of the following example information: resources for channel measuring (e.g., RSRP, RSRQ, etc.); report type to be periodic, aperiodic, or semi-persistent; periodicity; slot offset; number of reported cells; and/or number of reported RSs per cell (e.g., see Table 3). For NZP CSI-RS resource(s) and/or resource set(s) for example, the WTRU may receive configuration information on one or more NZP CSI-RS resources and/or NZP CSI-RS resource sets associated with the corresponding candidate cell for LTM cell switch. For SSB Config for example, the WTRU may receive one or more configuration information on the SSB associated with the candidate cell based on which the WTRU may perform RRM measurements for the corresponding candidate cell. In an example, the configuration on the SSB may include any of the following example information: the frequency of the SSBs; SSB burst's periodicity; time domain position of the transmitted SSBs in an SSB burst (e.g., via ssb-PositionsInBurst); SSBs' subcarrier spacing; and/or SSB's secondary synchronization signal's (SS) energy per resource element (EPRE).

Procedures for evaluating LTM events based on a candidate cell are described herein. A WTRU may be configured and/or indicated with a first set of (e.g., activated) TCI-states for measuring one or more channel and/or interference parameters from a serving cell. The WTRU may be configured and/or indicated with a second set of (e.g., activated) TCI-states for measuring one or more channel and/or interference parameters from a neighbor, non-serving, and/or candidate cell.

In an example, (e.g., as part of LTM cell switching procedure) a WTRU may use the configured and/or indicated second set of TCI-states for measuring one or more quality parameters (e.g., RSRP, RSRQ, SINR, etc.). In an example, the WTRU may measure the quality parameters based on one or more RSs from the candidate cell (e.g., SSB, CSI-RS, etc.). For example, the WTRU operating in SBFD resources may use the DL subband for receiving and measuring the RSS from the candidate cell. In another example, the WTRU operating in SBFD resources may use the UL subband for receiving and measuring the signal strength from the candidate cell.

In an example, a WTRU may use one or more configured and/or indicated second TCI states for measuring CLI based on one or more configured CLI measurement resources from a candidate cell. In an example, the WTRU may determine, be configured, and/or indicated to measure CLI in the same symbols and/or at the same time as SSB transmission from the candidate cell. In another example, the WTRU may determine, be configured, and/or indicated to measure CLI in the one or more CLI measurement resources that are determined, configured, and/or indicated to be associated with at least an SSB transmission occasion from the candidate cell. In an example, the WTRU may perform the CLI measurement from the candidate cell as part of LTM cell switching procedure. For example, the WTRU may determine, be configured, and/or indicated to measure CLI-RSSI, SRS-RSRP, etc. from the candidate cell. In an example, the WTRU operating in SBFD resources may use the CLI measurement resources configured in the UL subband for receiving and measuring the CLI from the candidate cell. In another example, the WTRU operating in SBFD resources may use the CLI measurement resources configured in the DL subband for receiving and measuring the CLI from the candidate cell. In an example, the WTRU may determine that the measured CLI may be caused by the WTRUs in the serving cell, as described herein.

Example modes of operation are described herein. In an example, in case a WTRU determines that measuring one or more quality parameters based on one or more RSs from a candidate cell may be impacted by CLI (e.g., measured CLI-RSSI more than a threshold), the WTRU may determine the mode of operation based on one or more conditions. For example, the WTRU may receive, be configured, and/or indicated with one or more configuration information and/or indications on one or more modes of operation. The WTRU may be configured and/or indicated with one or more conditions, based on which the WTRU may choose the mode of operation. For example, the WTRU may receive the configuration information and/or indications (e.g., via SIB, RRC, MAC-CE, DCI, etc.). In an example, one or more of the following example modes of operation may apply: first mode of operation; second mode of operation; and/or third mode of operation.

For example, a first mode of operation may use the second type SSB bursts. A WTRU may determine, be configured, and/or indicated to operate based on the first mode of operation if the number of measured strong CLI (e.g., CLI higher than a threshold) based on SSBs in different SSB bursts, for example in a configured time window, is higher than a configured MAX number. In an example, the WTRU may receive one or more configuration information including a time window, where the time window may be the same as the time window configured for measuring, filtering, and/or evaluating the measured RSRPs. In another example, the received configuration information may include the MAX number of measured strong CLI based on SSBs in different SSB bursts in the configured time window.

The WTRU may initiate a counter to a first value (e.g., zero). The WTRU may measure one or more quality parameters based on SSBs in a first type SSB burst. The WTRU may measure the CLI (e.g., L1-CLI-RSSI) in CLI measurement resources associated with one or more SSBs within the configured time window. In case any of the measured CLI is higher than a threshold value, the WTRU may increment the counter by a second value (e.g., one). At the end of the time window, in case the evaluated counter is higher than the MAX number, the WTRU may trigger an event to switch the mode of operation and to operate based on the first mode of operation. In the first mode of operation, the WTRU may use, detect, and/or measure the second type SSB bursts (e.g., clean SSB bursts) for measuring channel quality parameters.

An example second mode of operation may skip the measurements affected by CLI. In an example, in case the number of SSB occasions that are determined to be affected by the CLI, for example in a configured time window, is lower than the configured MAX number, the WTRU may determine to trigger an event to switch the mode of operation and to use the second mode of operation. As such, the WTRU may skip and/or discard the RSRP measurements based on the SSB occasions that are affected by the CLI in evaluating, calculating, and/or averaging the RSRP measurements in the configured time window. In another example, the WTRU may apply at least one bias parameter (e.g., a function, a penalty parameter, a prioritization parameter, a weighting factor or coefficient affecting evaluation of the SSB measurement) based on (e.g., on top of, in combination with) the RSRP measurements based on the SSB occasions that are affected by the CLI, e.g., in determining, evaluating, calculating, and/or averaging the RSRP measurements in the configured time window.

An example third mode of operation may use the first type SSB busts. In an example, the WTRU may receive one or more configuration information including a time window, and a MIN number of measured strong CLI based on SSBs in different SSB bursts in the configured time window. In an example, in case the number of SSB occasions that are determined to be affected by the CLI, for example in a configured time window, is lower than the configured MIN number, the WTRU may trigger an event to switch the mode of operation and to use the third mode of operation. In another example, if the previous mode of operation is based on the third mode of operation, the WTRU may not trigger any events and the WTRU may continue operating based on the third mode of operation. That is, in case the SSB measurements based on first type SSB bursts is not affected by the CLI, the WTRU may continue using the first type SSB bursts. As such, the WTRU may use the first type SSB bursts for measuring the quality parameters.

In an example, the WTRU may use the measured quality parameters for evaluating one or more LTM events. For example, in case the WTRU determines to operate based on the first mode of operation, one or more of the following examples may apply: event LTM3; event LTM4; and/or event LTM5. In event LTM3 for example, the WTRU may determine to trigger event LTM3 if the beam of the candidate cell, measured based on the second type SSB burst, becomes amount of offset and/or threshold value better than beam of the serving cell. In event LTM4 for example, the WTRU may determine to trigger event LTM4 if the beam of candidate cell, measured based on the second type SSB burst, becomes better than an absolute threshold. In event LTM5 for example, the WTRU may determine to trigger event LTM5 if the beam of serving cell becomes worse than absolute threshold1 AND beam of candidate cell, measured based on the second type SSB burst, becomes better than an absolute threshold2.

Example procedures for reporting are described herein. A WTRU may determine, be configured, and/or indicated to send a report (e.g., to a gNB). In an example, the WTRU may initiate a mobility report, for example based on the criteria for reporting of the (LTM) measurement events. In an example, the report may include any of the following example information: indication of the event (mobility event ID); indication of SR (for transmission of the MAC CE containing further results, possibly with the report size); and/or measurement result for the (mobility) event.

The WTRU may report the measured CLI, where the CLI may be measured in association with one or more SSBs received from a candidate cell. In an example, the WTRU may be configured with one or more report configuration (e.g., CSI report configuration) for reporting the measured CLI. The report configurations may include any of the following example information: the time and frequency grants for sending the report; and/or the type of the CLI report including periodic semi-persistent, and/or aperiodic. In an example, the CLI report may be sent as part of the mobility report. In another example, the CLI report may be sent separate from the mobility report based on a separate (e.g., CSI) report configuration. In an example, the WTRU may determine, be configured, and/or indicated to report the measured CLI if the WTRU determines that the source of CLI is from a candidate cell, as described herein on determining the source of CLI. In another example, the WTRU may determine, be configured, and/or indicated to report the measured CLI if the WTRU determines that the source of CLI is from the serving cell, as described herein. In another example, the WTRU may determine, be configured, and/or indicated to report the measured CLI if the measured CLI is higher than a configured CLI-MAX threshold value.

In an example, the WTRU may send a report including any of the following example information: SSB burst type; measured CLI; TCI-state; associated SSB index; candidate cell; time instances where CLI was detected and/or measured; frequency resources; whether CLI was measured in SBFD or non-SBFD symbols; and/or whether CLI was measured in symbols overlapping with SSBs.

Regarding SSB burst type for example, the WTRU may indicate the type of the SSB burst, based on which the CLI was measured. For example, the WTRU may send a flag indication, where a first value (e.g., zero) may indicate that the CLI measurement and reporting may be based on the first type SSB bursts; a second value (e.g., one) may indicate that the CLI measurement and reporting may be based on the second type SSB bursts (e.g., clean SSB bursts). Regarding measured CLI for example, the WTRU may report the measured CLI (e.g. CLI-RSSI, SRS-RSRP, etc.). TCI-state (or RS, directly) may be used for measuring the CLI. For example, the WTRU may report the TCI-state (or RS index) that the WTRU used for measuring the reported CLI. In an example, the TCI-state (or RS) may be associated with a beam direction towards the candidate cell. Regarding associated SSB index for example, the WTRU may report the SSB index, for which the measurement on the quality parameters (e.g., RSRP, RSRQ, SNR, etc.) may be affected by the reported CLI. In an example, the reported SSB index may be from a candidate cell.

Regarding candidate cell for example, the WTRU may report the candidate cell, e.g., corresponding cell ID and/or PCI, for which the quality parameters measurement may be affected by the reported CLI. Regarding time instances where CLI was detected and/or measured for example, the WTRU may report the time instances (e.g., symbols, slots, etc.) including the starting symbol, the time duration, and/or the end symbol during which the reported CLI was measured. In another example, the WTRU may indicate the time instances during which the CLI was detected to be higher than one or more threshold values. In an example, the WTRU may indicate that the CLI measurement was only based on a subset of CLI measurement resources, where the measured CLI was higher than a threshold. In an example, the WTRU may indicate that the CLI measurement was based on all configured CLI measurement resources, regardless of whether the measured CLI was higher or lower than a threshold.

Regarding frequency resources for example, the WTRU may report the frequency resources (e.g., RBs) including the starting RB, the RB length, and/or the end RBs which the reported CLI was measured. In another example, the WTRU may indicate if the CLI measurements was performed in the UL subband or the DL subband. In another example, the WTRU may indicate that the reported CLI was measured in RBs that were fully overlapping, partially overlapping, or non-overlapping with SSB RBs. Regarding whether CLI was measured in SBFD or non-SBFD symbols for example, the WTRU may indicate whether the reported CLI was measured in SBFD or non-SBFD symbols. Regarding whether CLI was measured in symbols overlapping with SSBs for example, the WTRU may indicate that the reported CLI was measured in symbols that were fully overlapping, partially overlapping, or non-overlapping with SSB symbols. In an example, the WTRU may indicate the overlapping with SSB symbols based on SSBs from the candidate cell.

Example handshake procedures between a WTRU and the network (NW) are described herein. In an example, in case the WTRU determines to change the mode of operation, the WTRU may transmit one or more reports and/or indications to indicate the determined mode of operation and optionally to receive a confirmation from the network. The report may include one or more information regarding the determined mode of operation. For example, the WTRU may transmit the report to a gNB, for example in its serving cell. In an example, the WTRU may send the report and/or indications (e.g., via UCI, MAC-CE, and/or RRC signaling). The indication and/or report may include one or more of the following information: determined mode of operation; time duration; and/or periodicity.

Regarding determined mode of operation for example, the WTRU may indicate the determined mode of operation via a flag indication, where a first value (e.g., zero) may indicate the first mode of operation; a second flag value (e.g., one) may indicate the second mode of operation; a third flag value (e.g., two) may indicate the third mode of operation. For example, the first mode of operation may indicate using second type SSB bursts for measuring quality parameters based on a (e.g., candidate) cell; the second mode of operation may indicate skipping the quality parameter measurements (e.g., in filtering, averaging, etc.) that may coincide with symbols where strong CLI (e.g., CLI higher than a threshold) may be measured; and the third mode of operation may be based on using the first type SSB bursts. In an example, in case the determined mode of operation has not changed since the previous reporting, the WTRU may not send the indication on the determined mode of operation. In the absence of the indication on the determined mode of operation, the NW may determine that the mode of operation has not changed.

Regarding time duration for example, the WTRU may indicate the time span, during which the WTRU may apply the determined mode of operation. In an example, the WTRU may indicate the starting time, the time duration, and or the end time. For example, the WTRU may indicate the time duration based on time instances (e.g., number of symbols, slots, frames, subframes, etc.). In another example, the WTRU may indicate the time duration based on time units (e.g., msec, micro sec, etc.). In another example, the WTRU may indicate the time duration based on the number of SSB bursts, for example N SSB bursts. That is, the WTRU may indicate that the WTRU may apply the determined mode of operation for the indicated number of configured and/or scheduled SSB bursts, for example N SSB bursts. Regarding Periodicity for example, the WTRU may indicate if applying the determined mode of operation may take place semi-persistently, periodically, or aperiodically. For example, the WTRU may determine the periodicity for applying the determined mode of operation based on the configured and/or indicated periodicity of first type SSB bursts and/or second type SSB bursts.

In an example, the WTRU may receive configurations, determine, and/or be (pre) configured with time and frequency resources to transmit the report and/or indications. For example, the WTRU may be configured or determine to transmit the report before or after applying the determined mode of operation. One or more of the following may apply: Indication before applying the determined mode of operation; and/or Indication after applying the determined mode of operation.

According to indication before applying the determined mode of operation for example, a WTRU that may be applying a first mode of operation may determine to switch and apply a second mode of operation. In an example, a WTRU that may be measuring quality parameters based on a first type SSB burst (e.g., third mode of operation) may determine to use a second type SSB burst (e.g., first mode of operation) and measure the quality parameters based on the second type SSB burst; a WTRU that may be measuring quality parameters based on a first type SSB burst (e.g., third mode of operation) may determine to skip one or more measurements due to measured strong CLI affecting the measurements (e.g., second mode of operation); a WTRU that may be measuring quality parameters based on the second type SSB burst (e.g., first mode of operation) may determine that the measured CLI is not strong anymore and therefor determine to use the first type SSB burst (e.g., third mode of operation) and measure the quality parameters based on the second type SSB burst.

The WTRU may be (pre) configured, indicated and/or determine to transmit the report before applying the determined mode of operation as soon as detecting one or more conditions and/or receiving the triggers to switch to the determined mode of operation. In an example, the WTRU may determine to transmit the report before applying the determined mode of operation, if for example there in a long enough time window between detecting the conditions and/or receiving the triggers and applying the required changes. For example, the WTRU may determine that the time window between receiving a second type SSB burst may be longer than a time threshold, wherein the WTRU may determine to transmit the report before applying the changes to measure based on the second type SSB burst.

In an example, the WTRU may be (pre) configured or determine to send the report as part of a (pre) configured CSI report. In another example, the WTRU may transmit a (special) scheduling request (SR), for example via (pre) configured PUCCH resources. As such, the WTRU may transmit the indication on the determined mode of operation and corresponding information as part of the transmitted SR. In another example, the WTRU may transmit the indication based on an enhanced codebook via HARQ-ACK, where a flag indication may include the indication on the determined mode of operation. In an example, the WTRU may receive an indication (e.g., from gNB) confirming or rejecting the change of mode of operation. For example, the WTRU may receive the confirmation or rejection indication (e.g., via DCI, MAC-CE, RRC, etc.).

According to indication after applying the determined mode of operation for example, a WTRU that is operating based on a first mode of operation may determine to apply a second mode of operation. The WTRU may be (pre) configured, receive indication, and/or determine to transmit the report after applying the determined mode of operation. One or more of the following may apply: via UCI and/or MAC-CE; and or HARQ-ACK. According to via UCI and/or MAC-CE for example, the WTRU may send the report as part of UCI and/or MAC-CE associated with the configured and/or scheduled UL transmission. In an example, the WTRU that is scheduled to transmit a PUCCH may include the report as part of the transmitted UCI. In another example, the WTRU that is scheduled to transmit a PUSCH may include the report as part of the transmitted MAC-CE. In an example, the WTRU may be configured to transmit the indication as part of a CSI report configuration. According to HARQ-ACK for example, the WTRU may send the report as part of HARQ-ACK transmission that is associated with the received indication on the measurement and/or report configuration. In an example, the WTRU may transmit an enhanced HARQ-ACK codebook, where the codebook may include a (flag) indication to indicate the determined mode of operation.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed:

1. A wireless transmit/receive unit (WTRU) configured to perform cell selection, the WTRU comprising:
a transceiver; and
a processor, wherein the transceiver and the processor are configured to:
measure a signal strength of one or more first synchronization signal block (SSB) bursts received from a first base station associated with a first cell;
calculate a cell ranking value of the first cell;
receive, from the first base station, configuration information for receiving one or more second SSB bursts from a second base station associated with a second cell and configuration information for receiving one or more third SSB bursts from the second base station associated with the second cell;
measure a signal strength of the one or more second SSB bursts received from the second base station, wherein the one or more second SSB bursts are received during first SSB symbols;
measure cross-link interference (CLI)-received signal strength indicator (RSSI) based on one or more signals received during the first SSB symbols;
based on the measured CLI-RSSI being above a threshold:
measure, from the second base station, a signal strength of the one or more third SSB bursts received from the second base station;
calculate a cell ranking value of the second cell based on the measured signal strength of the one or more second SSB bursts and the measured signal strength of the one or more third SSB bursts; and
perform cell selection by selecting a cell with a highest calculated cell ranking value.

2. The WTRU of claim 1, wherein the first cell is a serving cell for the WTRU.

3. The WTRU of claim 1, wherein the configuration information for receiving the one or more second SSB bursts and the configuration information for receiving the one or more third SSB bursts are received in a system information block (SIB).

4. The WTRU of claim 1, wherein the configuration information for receiving the one or more second SSB bursts and the configuration information for receiving the one or more third SSB bursts indicate at least one of: parameters, thresholds, or periodicity.

5. The WTRU of claim 1, wherein the measured signal strength of the one or more first SSB bursts, the one or more second SSB bursts, and the one or more third SSB bursts is a reference signal received power (RSRP).

6. The WTRU of claim 1, wherein the one or more third SSB bursts are clean bursts received in a time period during which no uplink transmission is performed in the first cell.

7. The WTRU of claim 1, wherein the CLI-RSSI is measured in one or more uplink subbands.

8. The WTRU of claim 1, wherein the one or more second SSB bursts are of a first type and the one or more third SSB bursts are of a second type and wherein the one or more third SSB bursts have a different periodicity than the one or more second SSB bursts.

9. The WTRU of claim 1, wherein the transceiver and the processor are further configured to:
connect to the selected cell with the highest calculated cell ranking value; and
send, to the selected cell, a reporting message, wherein the reporting message indicates one or more of: the measured CLI-RSSI or an indication that the cell ranking value of the second cell was based on a clean SSB burst.

10. The WTRU of claim 1, wherein the WTRU is configured to communicate using one or more subband non-overlapping full duplex (SBFD) subbands.

11. A method for cell selection performed by a wireless transmit/receive unit (WTRU), the method comprising:
measuring a signal strength of one or more first synchronization signal block (SSB) bursts received from a first base station associated with a first cell;
calculating a cell ranking value of the first cell;
receiving, from the first base station, configuration information for receiving one or more second SSB bursts from a second base station associated with a second cell and configuration information for receiving one or more third SSB bursts from the second base station associated with the second cell;
measuring a signal strength of the one or more second SSB bursts received from the second base station, wherein the one or more second SSB bursts are received during first SSB symbols;
measuring cross-link interference (CLI)-received signal strength indicator (RSSI) based on one or more signals received during the first SSB symbols;
based on the measured CLI-RSSI being above a threshold:
measuring, from the second base station, a signal strength of the one or more third SSB bursts received from the second base station;
calculating a cell ranking value of the second cell based on the measured signal strength of the one or more second SSB bursts and the measured signal strength of the one or more third SSB bursts; and
performing cell selection by selecting a cell with a highest calculated cell ranking value.

12. The method of claim 11, wherein the first cell is a serving cell for the WTRU.

13. The method of claim 11, wherein the configuration information for receiving the one or more second SSB bursts and the configuration information for receiving the one or more third SSB bursts are received in a system information block (SIB).

14. The method of claim 11, wherein the configuration information for receiving the one or more second SSB bursts and the configuration information for receiving the one or more third SSB bursts indicate at least one of: parameters, thresholds, or periodicity.

15. The method of claim 11, wherein the measured signal strength of the one or more first SSB bursts, the one or more second SSB bursts, and the one or more third SSB bursts is a reference signal received power (RSRP).

16. The method of claim 11, wherein the one or more third SSB bursts are clean bursts received in a time period during which no uplink transmission is performed in the first cell.

17. The method of claim 11, wherein the CLI-RSSI is measured in one or more uplink subbands.

18. The method of claim 11, wherein the one or more second SSB bursts are of a first type and the one or more third SSB bursts are of a second type and wherein the one or more third SSB bursts have a different periodicity than the one or more second SSB bursts.

19. The method of claim 11, further comprising:
connecting to the selected cell with the highest calculated cell ranking value; and
sending, to the selected cell, a reporting message, wherein the reporting message indicates one or more of: the measured CLI-RSSI or an indication that the cell ranking value of the second cell was based on a clean SSB burst.

20. The method of claim 11, wherein the WTRU is configured to communicate using one or more subband non-overlapping full duplex (SBFD) subbands.
